(19) United States
(12) Patent Application Publication
(10) Pub. No.: US 2022/0076279 A1
(43) Pub. Date: Mar. 10, 2022

(54) MARKETING ENGINE BASED ON TRAITS AND CHARACTERISTICS OF PROSPECTIVE CONSUMERS

(71) Applicant: AFFINIO INC., Halifax (CA)

(72) Inventor: Philip Joseph RENAUD, Toronto (CA)

(21) Appl. No.: 17/413,479

(22) PCT Filed: Dec. 24, 2019
(86) PCT No.: PCT/IB2019/061346

§ 371 Date: Jun. 11, 2021

Related U.S. Application Data
(60) Provisional application No. 62/784,593, filed on Dec. 24, 2018.

(51) Int. Cl. G06Q 30/02; G06K 9/62

(52) U.S. Cl. CPC G06Q 30/0201; G06K 9/6223

(57) ABSTRACT

A method and apparatus for machine-aided marketing are disclosed. A hardware processor executes instructions for tracking a population of social-media users, segmenting the population of users into a set of clusters based on individual user properties, acquiring metrics of user behaviour, and determining saturation of candidate metrics within each cluster based on the individual user metrics. The method identifies a set of distinctive metrics and corresponding distinct clusters according to metric-saturation levels. To promote a specific commodity, the method determines compatible distinctive metrics and at least one distinct cluster. Various means of communicating with users of the at least one distinct cluster may then be employed.

### CROSS-REFERENCE TO RELATED APPLICATIONS

The present application claims the benefit of provisional application 62/784,593 filed on Dec. 24, 2018, entitled “Marketing Method and Apparatus based on Trait-Character Linkage of Segmented Network Members”, the entire content of which is incorporated herein by reference.

### FIELD OF THE INVENTION

The present invention relates to machine-aided marketing where marketing approaches are determined according to properties as well as observed behaviour of prospective consumers.

### BACKGROUND

Marketing decisions for a commodity are typically based on conjectured nature of prospective consumers of the commodity. Collecting data characterising a population of consumers is essential for enabling a focused marketing effort. Conventionally, the sought population-characterizing data includes slowly-varying properties (such as annual income), quasi-permanent properties (such as height of an adult, gender, etc.), and/or permanent characteristics such as place of birth. Evolving properties such as favourite entertainment or sport, political and social-behaviour inclinations, and the like, are not used for directing the marketing effort.

There is a need, therefore, to explore improvement of knowledge-based marketing based on both properties and varying traits of a target population of consumers.

### SUMMARY

The invention provides methods and apparatus for machine-aided marketing.

In accordance with one aspect, the invention provides a method of machine-aided marketing where a marketing engine is employed to track a plurality of users to acquire individual user characteristics of a predefined set of characteristics and individual user metrics of a predefined set of metrics of behaviour. The plurality of users is segmented into a plurality of clusters, each cluster comprising users selected according to mutual affinity based on the individual user characteristics. A metric-saturation level of each metric of the plurality of metrics within a cluster of the plurality of clusters is then determined as a function of a proportion of users within the cluster to which the specific metric pertains. This applies to each cluster of the plurality of clusters. For each metric, a respective set of target clusters within the plurality of clusters is determined according to metric-saturation levels.

Upon receiving an identifier of a specific commodity from an operator of the marketing engine, a set of relevant metrics for the specific commodity; is selected from the predefined set of metrics. For each relevant metric, a set of target clusters is determined. A target cluster may correspond to more than one relevant metric. Thus, the marketing engine communicates with users belonging to a union of sets of target clusters corresponding to the set of relevant metrics.

Alternatively, upon selecting the set of relevant metrics, a set of communities having a one-to-one correspondence to the set of relevant metrics, where each community comprises users to which a relevant metric pertains, is formed. A union of the set of communities and the sets of target clusters corresponding to the set of relevant metrics is determined. The marketing engine then communicates with users belonging to the union.

In one implementation, the following processes determine the set of relevant metrics for a specific commodity:
(i) acquiring metrics, belonging to the predefined set of metrics, of individual past consumers of the specific commodity;
(ii) determining a metric-relevance score for each metric of the predefined set of metrics as a number of past consumers to which the metric pertains; and
(iii) including a metric in the set of relevant metrics subject to a determination that a corresponding metric-relevance score exceeds a prescribed threshold.

In another implementation, the set of relevant metrics for a specific commodity is acquired from an operator of the marketing engine.

A metric-specific set of target clusters for a specific metric may be determined according to the following processes:
(a) initializing the metric-specific set of target clusters for the specific metric as an empty set; and
(b) for each cluster of the plurality of clusters:
   (b.1) determining a ratio of a respective metric-saturation level to mean metric-saturation level of remaining clusters; and
   (b.2) adding the cluster to the metric-specific set of target clusters subject to a determination that the ratio exceeds a predefined singularity threshold.

More specifically, a metric-specific set of target clusters for a specific metric may be determined according to the following processes:
(A) initializing the respective set of target clusters as an empty set;
(B) for each metric Mⱼ, 0≤j<μ, μ being a number of metrics of the predefined set of metrics:
   (B.1) determining a summation Σⱼ of S_{j,0} to S_{j,(K-1)}, K being a number of clusters of the plurality of clusters and S_{j,k} being a saturation score of metric j within cluster k;
   (B.2) determining a singularity l_{j,k} of metric-saturation of metric Mⱼ within a cluster k, 0≤k<K, as:

η_{j,k}=(K−1)×S_{j,k}/(Σⱼ−S_{j,k});
and
(B.3) subject to a determination that η_{j,k}>H, H being a predefined singularity threshold adding cluster k to the respective set of target clusters.

Alternatively, a metric-specific set of target clusters for a specific metric may be based on relative saturation according to the following processes:
(I) initializing the respective set of target clusters as an empty set;
(II) for each metric Mⱼ, 0≤j<μ, μ being a number of metrics of the set of candidate metrics:
   (II.1) determining a relative saturation α_{j,k} of Mⱼ, as α_{j,k}=S_{j,k}/Qₖ, Qₖ being a total number of users of cluster k, 0≤k<K, K being a number of clusters of the plurality of clusters and Sj, k being a saturation score of metric j within cluster k;
   (II.2) determining a summation Γⱼ of α_{j,0} to α_{j,(K-1)};
   determining a singularity λ_{j,k} of metric-singularity of metric Mⱼ within a cluster k, 0≤k<K, as:

λ_{j,k}=(K−1)×α_{j,k}/(Γⱼ−α_{j,k})
and
(I.3) subject to a determination that λ_{j,k}>H, H being a predefined singularity threshold adding cluster k to the set of bearing clusters.

In accordance with another aspect, the invention provides a method of machine-aided marketing based on employing a marketing engine to perform processes of receiving an identifier of a commodity from an operator of the marketing engine, identifying a set of relevant metrics to the commodity from a predefined set of metrics of personal behaviour, and determining a metric-relevance level of each of the relevant metrics. The engine determines a metric-saturation level of each relevant metric within each cluster of a set of clusters of users of a plurality of users of social-media as well as a relevance-weighted metric-saturation level for each relevant metric for each cluster where each saturation level is multiplied by a respective metric-relevance level. Subsequently, a commodity-specific cluster merit for each cluster of the superset of clusters is determined as a summation of respective relevance-weighted saturation levels;

A set of target clusters may then be determined based on commodity-specific cluster merits where each cluster having a cluster merit surpassing a prescribed threshold is included in the set of target clusters. The marketing engine communicates with users belonging to the set of target clusters.

The operator of the marketing engine may select the set of relevant metrics and provide corresponding metric-relevance levels. Alternatively, the set of relevant metrics and corresponding metric-relevance level of each relevant metric may be determined according to metric-relevance indications of individual consumers of a set of past consumers of the commodity.

The plurality of users is segmented into the set of clusters according to mutual affinity of individual users. A metric-saturation of a specific metric within a specific cluster is a function of a proportion of users of the specific cluster to which the specific metric pertains. The relevance weighted metric saturation level of a specific metric within a specific cluster is a product of a metric-relevance level of the specific metric and a metric-saturation of the specific metric within the specific cluster.

In accordance with a further aspect, the method comprises further processes of forming a set of communities having a one-to-one correspondence to the set of relevant metrics, each community comprising users to which a relevant metric pertains. The marketing engine determines a union of the set of communities and the set of target clusters. Thus, instead of communicating with users belonging to the set of target clusters, the marketing engine communicates with users belonging to the union of set of target clusters and the set of communities.

In accordance with a further aspect, the invention provides an apparatus comprising a hardware processor and a plurality of memory devices. Stored processor-executable instructions are organized into software modules including:
(i) a network interface for tracking users;
(ii) a module for acquisition of users' characterization data from a first plurality of tracked users;
(iii) a module for segmenting the first plurality of tracked users into a plurality of clusters according to users' characterization data;
(iv) a module for acquisition of metrics of a predefined set of metrics representing behaviour of a second plurality of tracked users;
(v) a module for determining a metric-saturation level of each metric in each cluster of the plurality of clusters as a function of a proportion of users of each cluster to which each metric pertains; and
(vi) a module for determining for each metric a respective set of target clusters within the plurality of clusters according to the metric-saturation level.

Modules (ii) to (vi) perform pre-processing functions aiming at providing information relevant to metric-specific target clusters. The information serves as a base for facilitating marketing functions including determining target clusters for a variety of commodities.

The apparatus further comprises a module for receiving an identifier of a specific commodity from an operator of the apparatus and selecting a set of relevant metrics of the predefined set of metrics for the specific commodity according to metric-relevance indications of individual consumers of a set of past consumers of the commodity. The apparatus further comprises a module for determining a union of sets of target clusters corresponding to the set of relevant metrics and communicating with users belonging to the union of sets of target clusters.

A module for acquisition of apparatus customization data from the operator is provided to enable selection of predefined thresholds and other control options. A module for routing data to users through a network is associated with the network interface.

### BRIEF DESCRIPTION OF THE DRAWINGS

Embodiments of the present invention will be further described with reference to the accompanying exemplary drawings, in which:

FIG. 1 illustrates an overview of a machine-aided marketing system, in accordance with an embodiment of the present invention;

FIG. 2 illustrates an overview of a marketing function, in accordance with an embodiment of the present invention;

FIG. 3 illustrates an overview of a marketing engine, in accordance with an embodiment of the present invention;

FIG. 4 illustrates components of a subsystem for clustering a population of users according to individual user characteristics, in accordance with an embodiment of the present invention;

FIG. 5 illustrates components of a subsystem for grouping users into communities according to individual user metrics, in accordance with an embodiment of the present invention;

FIG. 6 illustrates exemplary communities of users;

FIG. 7 illustrates a process of transforming user-cluster association to metric-cluster (or trait-cluster) association, in accordance with an embodiment of the present invention;

FIG. 8 illustrates components of a subsystem for determining metric-saturation levels within clusters, in accordance with an embodiment of the present invention;

FIG. 9 illustrates a method of determining metric-saturation levels within clusters, in accordance with an embodiment of the present invention;

FIG. 10 illustrates components of a first subsystem for determining target clusters or target communities according to seed-users saturation for a specific commodity, in accordance with an embodiment of the present invention;

FIG. 11 illustrates a method of determining metrics relevant to a specific commodity, in accordance with an embodiment of the present invention;

FIG. 12 illustrates a visualization of a process of selecting target clusters based on saturation levels of seed users within a superset of clusters, in accordance with an embodiment of the present application;

FIG. 13 illustrates a visualization of a process of target-communities selection based on saturation levels of seed users within a superset of communities, in accordance with an embodiment of the present application;

FIG. 14 illustrates the union of target clusters and target communities;

FIG. 15 illustrates components of a second subsystem for determining target clusters for a specific commodity according to metric saturation levels within clusters and metrics relevant to a specific commodity, in accordance with an embodiment of the present invention;

FIG. 16 illustrates a first stage of an intelligent-marketing engine, in accordance with an embodiment of the present invention;

FIG. 17 illustrates a second stage of the intelligent-marketing engine, in accordance with an embodiment of the present invention;

FIG. 18 illustrates a first plurality of users tracked to acquire quasi-static user characteristics and a second plurality of users tracked to acquire current user behaviour, for use in an embodiment of the present invention;

FIG. 19 illustrates attributes for characterizing users and metrics for indicating current interests of users, for use in an embodiment of the present invention;

FIG. 20 illustrates an alternate representation of a system for intelligent marketing, in accordance with an embodiment of the present invention;

FIG. 21 illustrates a method for intelligent marketing, in accordance with an embodiment of the present invention;

FIG. 22 illustrates clusters of users of high mutual affinity based on users' characteristics (properties) and a set of users of a common metric (common interest/common behaviour), the users including members of different clusters, for use in an embodiment of the present invention;

FIG. 23 illustrates intersecting communities, each community comprising a set of users of a common metric, where a user may have multiple metrics, for use in an embodiment of the present invention;

FIG. 24 visualizes a process of determining metric saturation within clusters, in accordance with an embodiment of the present invention;

FIG. 25 illustrates associating users with clusters and metrics;

FIG. 26 illustrates metrics' saturations within clusters;

FIG. 27 illustrates traits' saturation within clusters;

FIG. 28 illustrates a method of determining metric saturation within clusters, in accordance with an embodiment of the present invention;

FIG. 29 illustrates a first method of determining distinctive metrics and corresponding sets of clusters, in accordance with an embodiment of the present invention;

FIG. 30 illustrates a method of determining metric singularities within different clusters, in accordance with an embodiment of the present invention;

FIG. 31 illustrates a variation of the method of FIG. 30;

FIG. 32 illustrates metric saturations within different clusters, in accordance with an embodiment of the present invention;

FIG. 33 illustrates metric singularities within different clusters, in accordance with an embodiment of the present invention;

FIG. 34 illustrates trait singularities within different clusters, in accordance with an embodiment of the present invention;

FIG. 35 illustrates determining trait scores within different clusters, in accordance with an embodiment of the present invention;

FIG. 36 illustrates exemplary trait saturation levels within clusters;

FIG. 37 illustrates determining metric singularities within different clusters based on both raw saturation levels and normalized saturation levels;

FIG. 38 illustrates a second method of determining distinctive metrics and corresponding sets of clusters, in accordance with an embodiment of the present invention;

FIG. 39 illustrates a variation of the second method of determining distinctive metrics and corresponding sets of clusters, in accordance with an embodiment of the present invention;

FIG. 40 illustrates determining clusters of significant presence of a specific trait employing the method of FIG. 38, in accordance with an embodiment of the present invention;

FIG. 41 illustrates determining clusters of significant presence of a specific trait employing the method of FIG. 39, in accordance with an embodiment of the present invention;

FIG. 42 illustrates clusters of significant metric saturation employing the method of FIG. 38 for metrics M₀, M₂, and M₈ based on the metric saturation levels of FIG. 32 and the metric singularities of FIG. 33;

FIG. 43 illustrates determining clusters of significant presence of a specific trait according to the method of FIG. 38 for an exemplary case;

FIG. 44 illustrates a process of sorting clusters in a descending order according to metric-saturation values and a process of determining cumulative saturation values for sorted clusters according to the method of FIG. 38;

FIG. 45 further illustrates the processes of FIG. 44;

FIG. 46 illustrates coefficients of deviation of saturation levels within different clusters, for use in an embodiment of the present invention;

FIG. 47 illustrates clusters of significant metric saturation;

FIG. 48 illustrates commodity-specific cluster selection, in accordance with an embodiment of the present invention;

FIG. 49 illustrates a method of determining cluster-relevance levels for a commodity, in accordance with an embodiment of the present invention;

FIG. 50 illustrates a method of determining commodity-specific cluster merit, in accordance with an embodiment of the present invention; and

FIG. 51 illustrates an overview of machine-aided marketing processes, in accordance with an embodiment of the present invention.

### REFERENCE NUMERALS

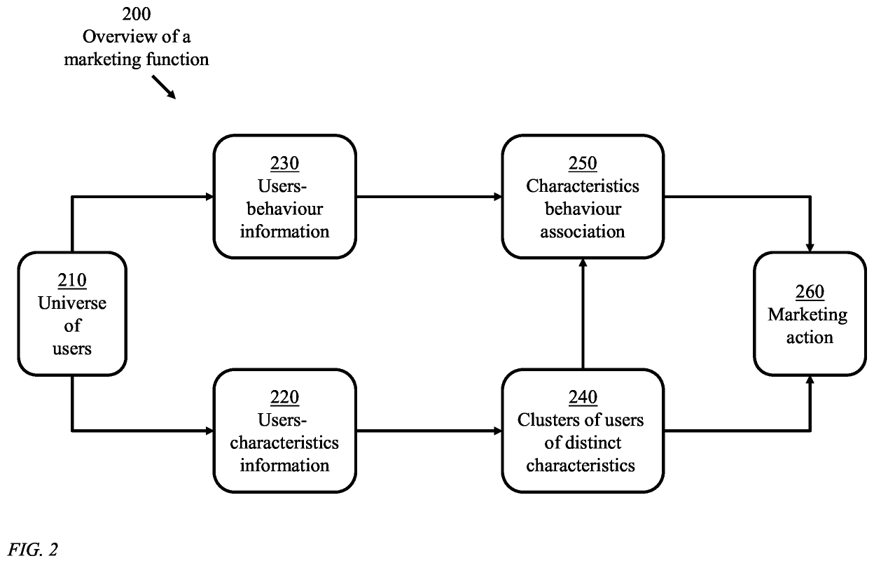

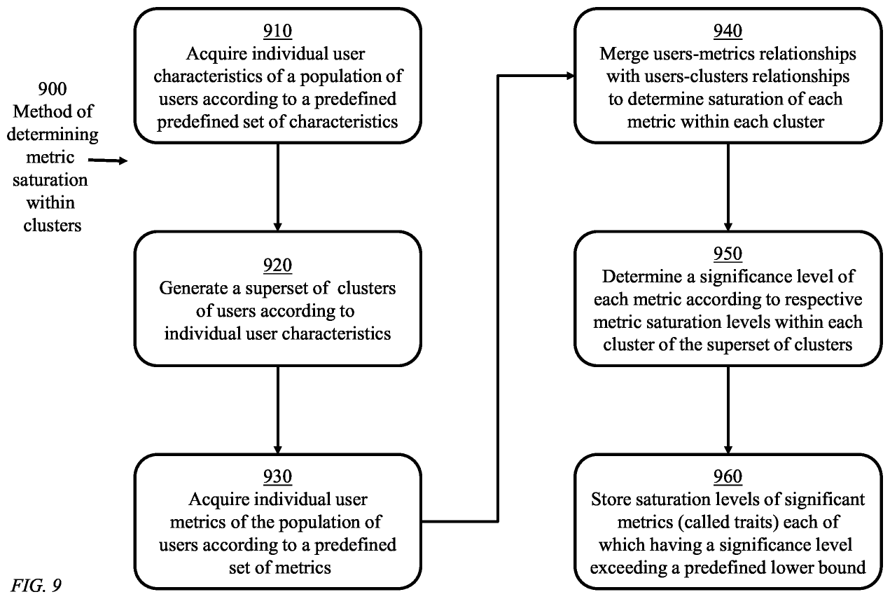

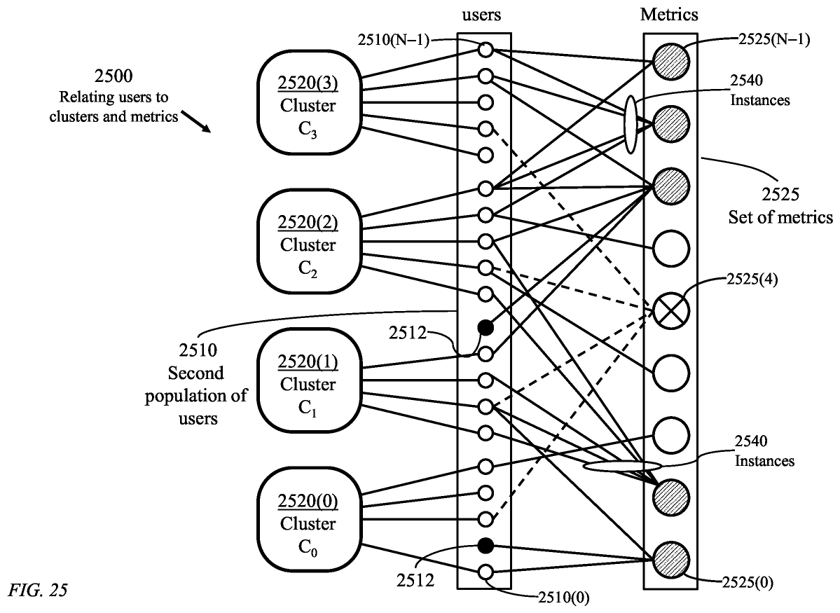

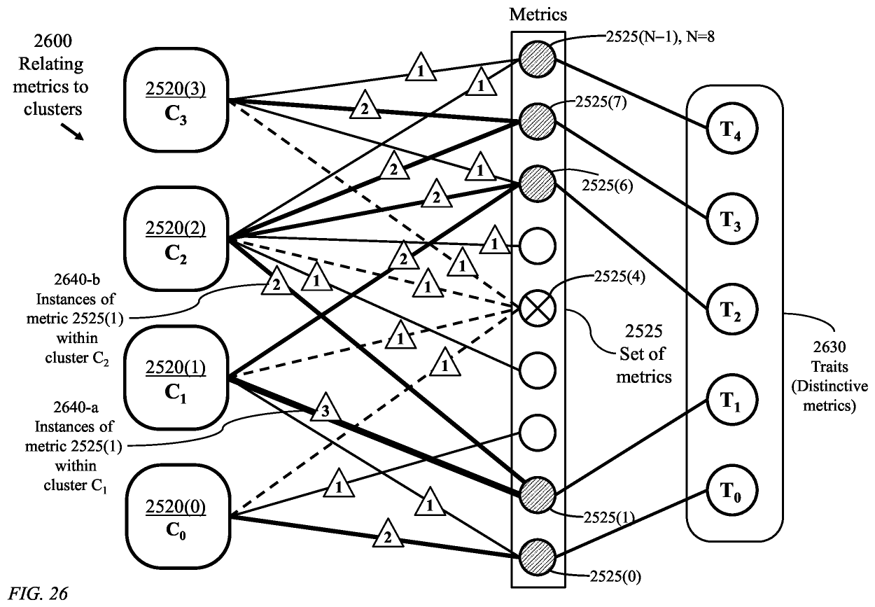

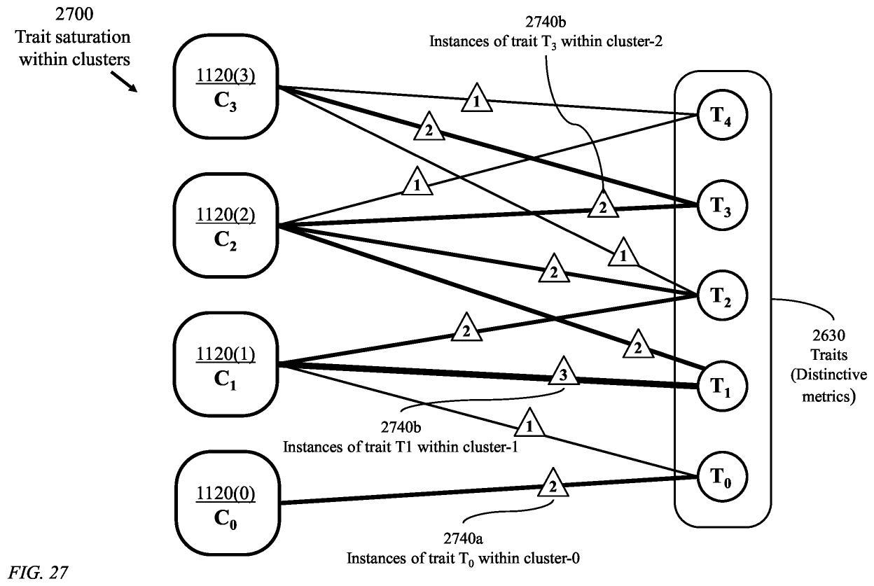

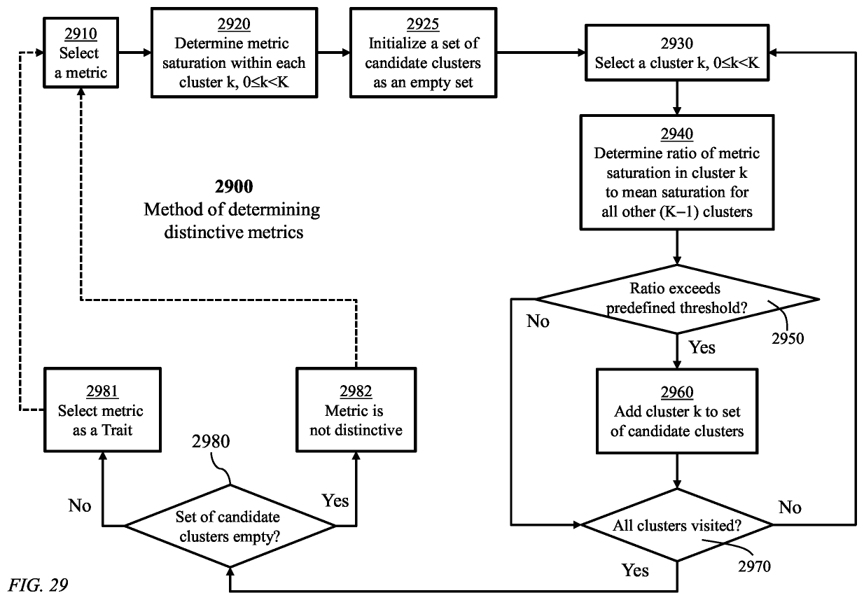

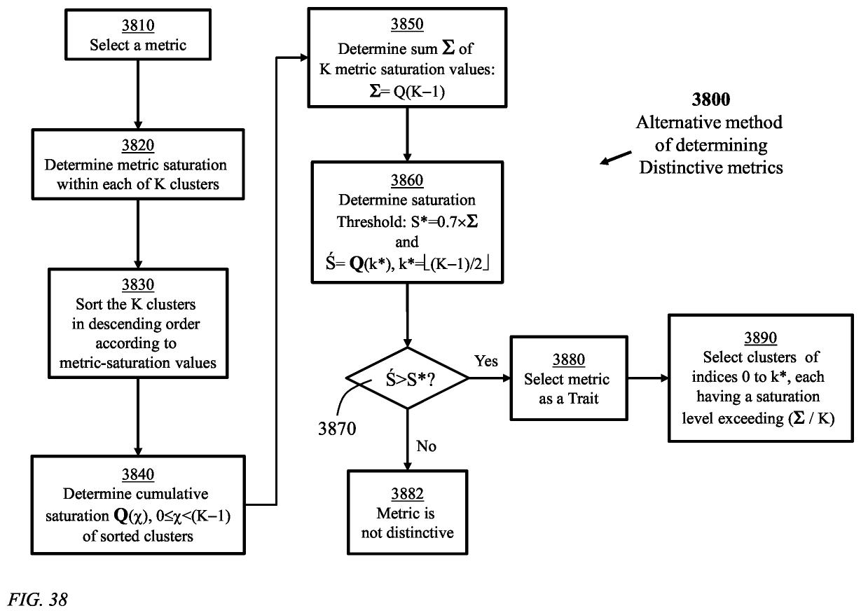

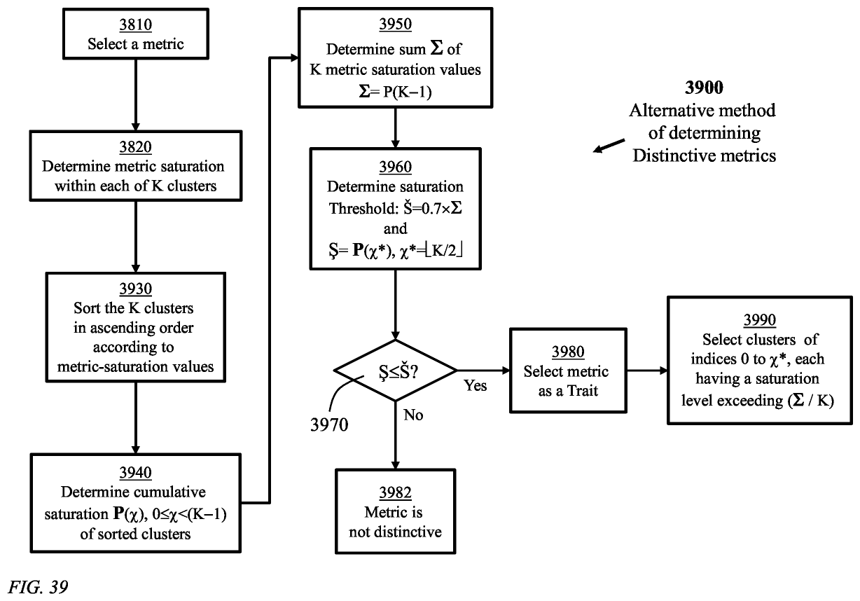

100: An overview of a marketing system
110: A communication network (such as the Internet)
120: Social-media server accessible through network 110 (four social-media servers 120 are illustrated, individually identified as 120-A, 120-B, 120-C, and 120-D which may belong to different owners)
140: User-tracking apparatus accessible through network 110, or directly coupled to a marketing engine 160 (Two user-tracking apparatus 140-A and 140-B are illustrated.)
160: Source of available users' search data
180: Marketing engine accessing social-media servers 120, user-tracking apparatus 140, and a population of user-devices through communication network 110 (Two marketing engines 160-A and 160-B are illustrated.)
200: An overview of a marketing function based on trait-character linkage of segmented users
210: Population of users
220: Data relevant to characteristics of users
230: Data relevant to conduct (behaviour) of users
240: Clusters' membership (composition of clusters of users of distinct characteristics)
250: Data relevant to traits saturation within clusters
260: Marketing actions based on clusters' traits and clusters' membership
300: An overview of marketing engine 180
310: Marketing-engine core
320: Individual consumer characteristics of a population of potential consumers
330: Individual consumer traits of the population of potential consumers
340: Individual consumer traits of past consumers of a specific commodity
350: Identifiers of likely consumers of the specific commodity
400: Components of a subsystem for clustering a population of users
420: Set of predefined user characteristics
440: Global tracked users' descriptors
460: A module for clustering users based on users' characteristics
480: Produced superset of clusters based on characteristics of the tracked population of users
500: Components of a subsystem for grouping users into communities according to individual user metrics or traits
505: Input data
510: A set of predefined user-conduct metrics
520: A set of commodity-specific seed users
530: User-conduct metrics of all tracked users
540: A module for classifying users according to user-conduct metrics, or user traits, to produce a superset of communities where users belonging to a community have a common metric or a common trait
550: A module for extracting metrics of a specific set of users
570: A module for identifying significant metrics
580: Produced superset of communities based on metrics or traits of the tracked population of users
590: Significant metrics corresponding to a specific commodity
610: Visualization of a user
620: A community of users of same metric
700: A process of transforming user-cluster association to traits-cluster (or metric-cluster) association
720: Tracked population of users
730: Process of clustering the population of users according to individual user characteristics to produce a superset of clusters (using module 460, for example)
750: Process of classifying the population of users according to individual user metrics or traits to produce a superset of communities (using module 540, for example)
770: Process of establishing direct association of metrics or traits with clusters (illustrated in FIG. 9) to supersede indirect linkage of clusters to metrics (or traits) through common users (FIG. 25, FIG. 26, FIG. 27)
780: Processes realizing direct association of metrics or traits with clusters (illustrated in FIG. 9)
800: Components of a subsystem for determining metric saturation (or trait saturation) within clusters
820: Module for mapping communities of users of common metrics or traits onto clusters of users
840: Resulting metric saturation (or trait saturation) within clusters
900: A method of determining metric saturation (or trait saturation) within clusters
910: A process of acquiring individual user characteristics
920: A process of generating a superset of clusters
930: A process of acquiring individual user metrics
940: A process of merging relationships of users to metrics with relationships of users to clusters to determine a saturation level of each metric within each cluster
950: A process of determining a significance level of each metric according to respective metric saturation levels within each cluster of the superset of clusters
960: A process of storing levels of significant metrics
1010: Components of a subsystem for determining significant clusters according to seed-users saturation within clusters for a specific commodity
1020: Components of a subsystem for determining significant communities according to seed-users saturation within communities for a specific commodity
1021: Data relevant to characteristics of seed users
1022: Data relevant to traits of seed users
1030: Process of determining seed-users' saturation within clusters
1040: Set of target clusters
1050: Process of determining seed-users' saturation within communities
1060: Set of target communities
1100: A process of determining relevant metrics (or relevant traits) for a specific commodity
1110: A set of seed users
1112: An identifier of a seed user
1120: A set of predefined metrics
1122: An indication of relevance of a metric to an individual seed user
1140: Metric-relevance scores
1142: Score of relevance of a specific metric to the specific commodity
1200: Visualization of target clusters based on seed-user saturation (subsystem 1010)
1220: Visualization of a user belonging to the first population of users
1230: Visualization of a seed user belonging to the first population of users
1300: Visualization of target communities based on seed-user saturation (subsystem 1020)
1320: Visualization of a user belonging to the second population of users
1330: Visualization of a seed user belonging to the second population of users
1400: Selection of target communities based on community intersection
1500: Components of a subsystem for determining target clusters for a specific commodity
1520: A module for identifying clusters corresponding to significant metrics
1540: Significant metrics or traits of the set of seed users corresponding to a specific commodity
1560: A set of target clusters for a specific commodity
1600: An apparatus constituting a first stage of an intelligent marketing engine
1610: A network interface for acquisition of data from a plurality of tracked users
1620: A hardware processor of the first stage which may be configures as multiple processing units operated concurrently in parallel or in a pipelined fashion
1630: A module (software instructions) for acquisition of apparatus customization data from an administrator of the marketing engine
1640: A module (software instructions) for acquisition of users' characterization data from a first plurality of users
1650: A module (software instructions) for segmenting the first plurality of users into clusters according to users' characterization data
1660: A module (software instructions) for acquisition of users' conduct data (also called “behaviour data” or “metrics”) from a second plurality of users
1670: A module (software instructions) for determining distinctive traits and corresponding sets of users or corresponding clusters of users
1680: Memory devices storing users' characterization data
1690: Memory devices storing users' conduct data
1700: An apparatus constituting a second stage of an intelligent marketing engine
1710: A hardware processor of the second stage which may be configures as multiple processing units
1720: A module (software instructions) for determining relationships of users' conduct to characteristics
1730: A module (software instructions) for determining marketing actions based on conduct-characteristics linkage
1740: A module (software instructions) for message generation and routing data through a network
1800: Visualization of tracked users of the universe 210 of users
1810: A first plurality of users that are tracked to acquire quasi-static characterization dat
1820: A second plurality of users that are tracked to acquire users' conduct data; the second plurality of users may overlap the first plurality of users
1900: Quasi-static users' characteristics versus changing metrics of users' conduct
1920: Tuples {u, V, W} indicating quasi-static characteristics of a user where “u” is a scalar identifying a user, V is a vector of ν elements each identifying a variable, and W is a vector of ν values having a one-to-one correspondence to the ν variables, ν>1
1921: User identifier
1922: Key-vector (vector of ν keys each key identifying a variable)
1923: Vector of ν values
1940: A predefined set of keys (a key vector)
1950: A set of metrics identifying users' conduct
1960: A subset of the set of metrics containing metrics determined to be significant and selected to constitute “traits”
2000: An alternate view of the first stage of the intelligent marketing engine of FIG. 2
2010: A module for observing a universe of users
2012: Processor-executable instructions for collecting tuples 1920
2014: Processor-executable instructions for collecting metrics 1950
2020: A module for segmenting users and filtering metrics to retain distinctive metrics (traits)
2022: Processor-executable instructions for segmenting users into clusters
2024: Processor-executable instructions for filtering metrics to retain distinctive metrics
2032: A module for identifying sets of users of respective similar traits
2034: A module for associating clusters with respective traits
2100: A method of intelligent marketing
2110: A process of acquiring definitions of a set of keys characterizing users
2112: A process of observing a first plurality of users of a universe of users
2114: A process of collecting variable-value pairs for detected users' activities
2116: A process of segmenting the first plurality of users into K clusters according to the collected key-value pairs, K>1
2120: A process of acquiring definitions of a set of metrics indicative of users' conduct (behaviour)
2122: A process of observing a second plurality of users of the universe of users
2124: A process of acquiring a collection of {user-metric} tuples corresponding to the set of metrics
2130: A process of relating each user of the second plurality of users to a cluster of the generated set of clusters
2132: A process of transforming the {user, metric} tuples to {cluster, metric} tuples
2134: A process of collating {cluster, metric} tuples into groups (incidences) each group corresponding to a single metric and a single cluster
2200: A process of mapping metric incidences onto clusters
2210: Users of a common trait of which:
   users 2210G and 2210H belong to a cluster C₀;
   users 2210A and 2210B belong to a cluster C₁;
   user 2210C belongs to a cluster C₂;
   users 2210E and 2210F belong to a cluster C₃; and
   users 2210D and 2210P do not belong to any of clusters C₀, C₁, C₂, and C₃ of the first plurality of clusters,
2220: A cluster of the first plurality of clusters comprising users of close key-value pairs.
2230: A community—a set of users having a common metric
2300 Visualization of intersecting trait sets
2330: Trait sets
2400: Process of determining metric saturation
2410: A set of users of same trait within a specific cluster
2430: Set of users 2210 of a specific trait set
2500: Illustration of relating users to clusters and metrics
2510: A set of users of the second plurality of users
2512: A user the characteristics of which are not available.
2520: A set of clusters of the first plurality of users
2525: A set of metrics (relevant to interests, conduct, . . . )
2540: A bundle of users of same metric but belonging to different clusters
2600: Illustration of saturation of metrics within clusters
2630: Distinctive metrics selected as traits
2640: Number of instances of a specific metric within a specific cluster
2700: Illustration of saturation of traits within clusters
2740: Number of instances of a specific trait within a specific cluster
2800: Method of determining metric saturation within clusters
2810: Process of detecting a metric-user tuple indicating an identity of a user and
corresponding metric
2820: Process of determining whether the user is already present in the registry
2830: Process of determining a cluster to which the user belongs
2840: Process of increasing cluster-metric score
2850: Process of attempting to obtain characteristics (properties) of the user to enable associating the user with an appropriate cluster
2860: Process of including the user in the registry
2870: Process of determining a specific cluster to which the user has the highest affinity in comparison with other clusters
2900: A first method of determining distinctive traits and corresponding clusters of users
2910: Instructions for selecting a metric of the set of metrics
2920: Instructions for determining metric saturation within each of K clusters, K>1
2925: Instructions for initializing a set of candidate clusters as an empty set
2930: Instructions for selecting a cluster k, 0≤k<K
2940: Instructions for determining a ratio of the metric saturation level in cluster k to the mean saturation level of all other (K−1) clusters
2950: Instructions for determining whether the ratio exceeds a predefine saturation threshold
2960: Instructions for adding cluster k to the set of candidate clusters
2970: Instructions for determining whether all of the K clusters have been considered
2980: Instructions for determining whether the set of candidate clusters is still empty
2981: Instructions for selecting the metric as a trait
2982: Instructions for discarding the metric as indistinctive
3000: A method of determining metric singularities within a plurality of clusters
3010: A process of selecting a metric M; from a set of μ metrics, μ>1
3020: A process of determining saturation values S_{j,k} for Mⱼ, 0≤k<K, within each of K clusters
3060: A process of determining a summation Σⱼ of saturation values S_{j,0} to S_{j,(K-1)}
3080: A process of determining singularity flₖ, 0≤k<K, of Mⱼ, within each of K clusters
3100: A variation of method 3000
3140: A process of obtaining membership (number of users) for each of K clusters—q(k), 0≤k<K, and determining relative metric saturation for each of μ metrics, μ>1, for each of the K clusters—α_{j,k}, 0≤j<μ, 0≤k<K
3160: A process of determining a summation Γⱼ of saturation values α_{j,0} to α_{j,(K-1)}
3180: A process of determining relative singularity λₖ, 0≤k<K, of Mⱼ, within each of K clusters
3600: Exemplary traits saturation levels
3620: A set of clusters
3630: A set of traits
3640: Saturation level of a specific trait within a specific cluster
3700: Determining metric singularities within clusters
3710: Raw saturation data
3720: Normalized saturation data
3800: A second method of determining distinctive metrics and corresponding clusters of users
3810: Process of selecting a metric of the set of metrics
3820: Process of determining metric saturation within each of K clusters, K>1
3830: Process of sorting K clusters in descending order according to metric saturation values
3840: Instructions for determining cumulative saturation values of sorted clusters
3850: Process of determining a sum Σ of K metric saturation values
3860: Process of determining a saturation threshold and a determinant saturation value
3870: Process of determining whether a metric is distinctive
3880: Process of selecting a metric as a trait
3882: Process of discarding the metric as indistinctive
3890: Process of selecting clusters of significant metric saturation
3900: A variation of the second method 3800 of determining distinctive metrics and corresponding clusters of users
3930: Process of sorting K clusters in ascending order according to metric saturation values
3940: Process of determining cumulative saturation values of sorted clusters
3950: Process of determining a sum Σ of K metric saturation values
3960: Process of determining a saturation threshold and a determinant saturation value
3970: Process of determining whether a metric is distinctive
3980: Process of selecting a metric as a trait
3982: Process of discarding the metric as indistinctive
3990: Process of selecting clusters of significant metric saturation
4000: An example of determining clusters of significant metric saturation based on the method of FIG. 38
4010: A count of clusters
4020: Cumulative distribution of score/cluster sorted in descending order
4030: Index of a metric
4040: An upper bound of cumulative distribution
4100: An example of determining clusters of significant metric saturation based on the method of FIG. 39
4120: Cumulative distribution of score/cluster sorted in ascending order
4140: A lower bound of cumulative distribution
4200: Illustration of distinctive metrics
4210: A distinctive metric
4220: Metric-saturation level within a cluster
4230: Cumulative metric-saturation value
4250: Mean value of metric-saturation level
4260: Concave-saturation threshold S*
4270: Coefficient of absolute deviation ε
4300: Comparison of results of the method of FIG. 29 and the method of FIG. 38 applied to determining clusters of significant presence of a specific metric
4320: Metric saturation levels sorted in a descending order
4430: Score of instances per cluster
4800: Process of commodity-specific target-clusters selection
4820: Superset of distinct clusters
4830: Overall community-cluster association
4832: Community-cluster association for commodity-A
4834: Community-cluster association for commodity-B
4836: Community-cluster association for commodity-C
4840: All communities of distinctive metrics
4842: Set-A of communities of metrics relevant to a first commodity
4844: Set-B of communities of metrics relevant to a second commodity
4846: Set-C of communities of metrics relevant to a third commodity
4862: Set-A of clusters corresponding to set-A of communities
4864: Set-B of clusters corresponding to set-B of communities
4866: Set-C of clusters corresponding to set-C of communities
4900: Weighted cluster-commodity relevance
4920: A commodity under consideration
4940: Metrics relevant to commodity
4960: Distinct clusters
5000: Method of determining commodity-specific cluster merit
5010: Process of acquiring information from an operator of the marketing engine of the invention including an identifier of a specific commodity 4920
5020: Process of identifying a set of metrics relevant to the specific commodity
5030: Process of determining a metric-relevance level of each relevant metric
5040: Process of determining a metric-saturation level of each relevant metric within each cluster of a superset of clusters
5050: Process of determining a relevance-weighted metric-saturation level for each relevant metric for each cluster
5060: Process of determining a commodity-specific cluster merit for each cluster of the superset of clusters.
5070: Process of communicating information relevant to a commodity to users
5100: An overview of machine-aided marketing processes
5140: Distinct clusters (clusters of significant trait saturation)
5160: Commodities of interest
5180: Process of determining commodity-user relationship
5190: Process of determining commodity-cluster relationship

### Terminology

User: The term refers to a member of a population under consideration for marketing purposes. The population may include users of social media or respondents to surveys, among many other entities. The terms “user” and “object” may be used synonymously in the present specification.

Information tracking system: The term refers to apparatus and means for interaction with an information dissemination system to identify patterns of users' access to information

Module: The term refers to processor-executable instructions stored in a memory device. The term “module” may also refer to a hardware entity comprising at least one hardware processor and associated memory devices storing relevant processor-executable instructions.

Characteristics of a user: The characteristics of a user represent slowly-varying properties (such as age or income), quasi-static properties (such as height of an adult), and/or permanent attributes such as place of birth. The characteristics of a user may comprise numerous attributes represented as a vector.

Conduct metrics of a user (an object): The conduct metrics (also referenced as behavior metrics or simply “metrics”) of a user represent evolving properties, such as societal views, favourite entertainment or sport, etc.

Clustering: The term refers to a widely used—yet still evolving—process of segmenting a plurality of users (such as users of social media) into groups (clusters) based on characteristics of individual users. The characteristics of an individual user may be exhibited as a vector of an arbitrary number of quantified scalars. A user belongs to only one cluster. The number of clusters may be predefined or determined automatically under specific constraints. A user may be characterized according to affiliation with one of a predefined number of clusters and, possibly, the user's proximity to the centroid of the cluster. Segmenting an entire population under consideration according to characteristics yields a superset of clusters.

Classifying: The term refers to a process of segmenting a plurality of users into groups (communities) based on conduct-metrics (behavior metrics) of individual users. Members of the population of users of a specific conduct form a respective community. The number of communities equals the number of predefined conduct metrics of interest. A user belongs to a one cluster but may belong to multiple communities. Segmenting an entire population under consideration according to conduct metrics yields a superset of communities.

Significant metric: A conduct metric is considered a significant metric subject to a determination that:
the ratio of the number of users of a respective community to the total number of users of a population under consideration exceeds a respective predefined threshold; and
saturation levels of the metric within a set of clusters under consideration have a variance exceeding a respective predefined threshold.

Traits of a user: Significant metrics are referenced as “traits”

Commodity: A commodity is a marketable product or service.

Distinct clusters: Clusters of a trait-saturation level exceeding a predetermined threshold are considered distinct clusters.

Seed users: Past consumers of a specific commodity that belong to the population of users under consideration are referenced as “seed users”.

Metric-saturation score within a cluster: The term refers to a number of users within the cluster to which a specific metric pertains. Thus, the intersection of a community of users of a specific conduct metric with the cluster defines a saturation score of the metric within the cluster.

Metric-saturation level within a cluster: Since clusters may be of different sizes (containing different numbers of users), a measure of saturation of a metric within different clusters is preferably prorated to a nominal cluster size. Thus, with a nominal cluster size of 1000, a metric having a metric saturation score of 200 within a cluster of 800 users and a saturation score of 100 within a cluster of 200 users is said to have a saturation level of (200×1000)/800 within the first cluster and a saturation level of (100×1000)/200 within the second cluster.

Metric-relevance score: A (commodity-specific) metric-relevance score of a specific metric with respect to a specific commodity is a count of a number of seed users to which the specific metric pertains. Thus, if metric M₁ is pertinent to 25 seed users of the specific commodity, then metric M₁ is said to have a metric-relevance score of 25.

Commodity-specific relevant metric: A metric is considered relevant to a commodity if the ratio of the metric-relevance score to the total number of seed users exceeds a predefined threshold.

Mean relevance score: With a number ν, ν>0, of relevant metrics with respect to a specific commodity, the mean relevance score is simply the mean value of ν metric-relevance scores Metric-relevance level: The term refers to the ratio of a (commodity-specific) metric-relevance score to the mean relevant scores. For example, with metric-relevance scores of four metrics of 20, 16, 24, and 40, the mean relevance score is 25 and the metric-relevance levels of the four metrics (with respect to a commodity) are 0.80, 0.64, 0.96, and 1.6.

Relevance-weighted saturation score: The term refers to a product of a saturation score of a metric within a cluster and a metric-relevance level of the metric.

Relevance-weighted saturation level: The term refers to a product of a saturation level of a metric within a cluster and a metric-relevance level of the metric.

Metric-specific cluster merit: A metric-specific cluster merit for a specific metric and a specific cluster is the relevance-weighted saturation level within the specific cluster of the specific metric.

Commodity-specific cluster merit: A commodity-specific cluster merit for a specific commodity and a specific cluster is the sum of relevance-weighted saturation levels within the specific cluster of all metrics determined to be relevant to the specific commodity.

Commodity-specific target cluster: For a specific commodity, a cluster determined to have a commodity-specific cluster merit exceeding a prescribed threshold is considered a target cluster (a cluster of prospective clients) for the commodity.

### DETAILED DESCRIPTION

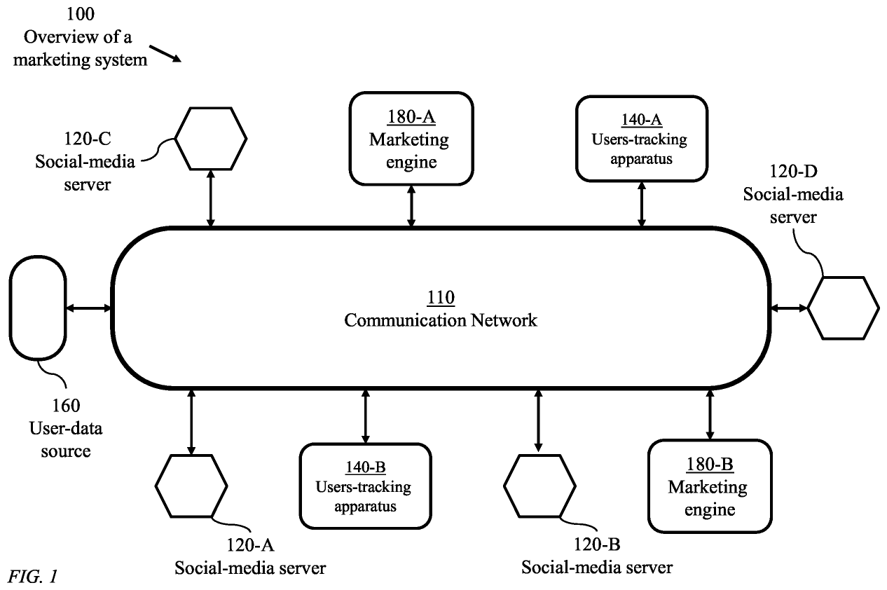

FIG. 1 illustrates an overview of a generic machine-aided marketing system 100. The generic system 100 comprises:
(I) at least one social-media server 120 accessible through a communication network 110, such as the Internet; four social-media servers 120 are illustrated, individually identified as 120-A, 120-B, 120-C, and 120-D which may belong to different owners;
(II) at least one user-tracking apparatus 140, each accessible through network 110, or directly coupled to a marketing engine 180; two user-tracking apparatus 140-A and 140-B are illustrated;
(III) at least one source 160 of available users' search data;
(IV) at least one marketing engine 180 comprising a hardware processor and memory devices and configured to access, through communication network 110, any of (i) a population of user-devices (not illustrated), (ii) social-media servers 120, (iii) user-tracking apparatus 140, and (iv) sources 160 of known users' search data; two marketing engines 180-A and 180-B are illustrated.

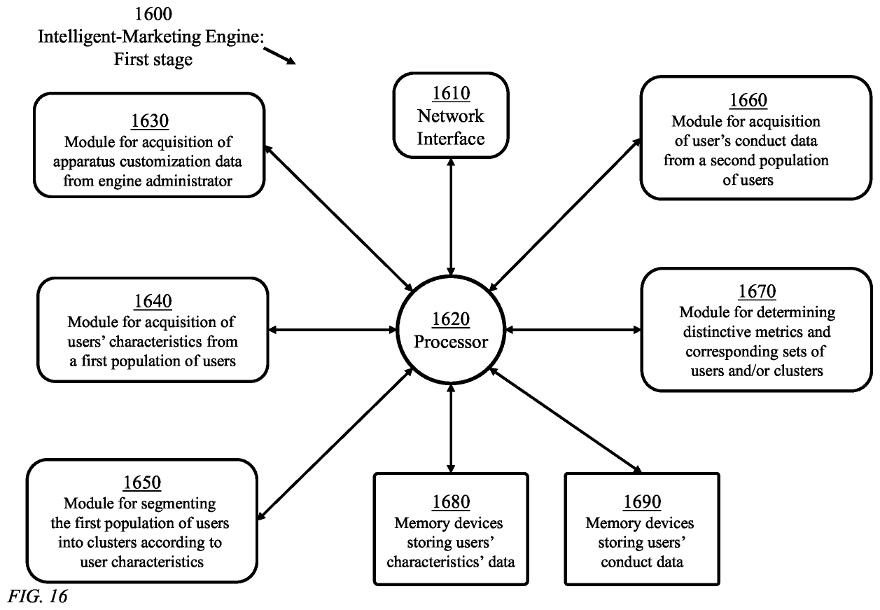

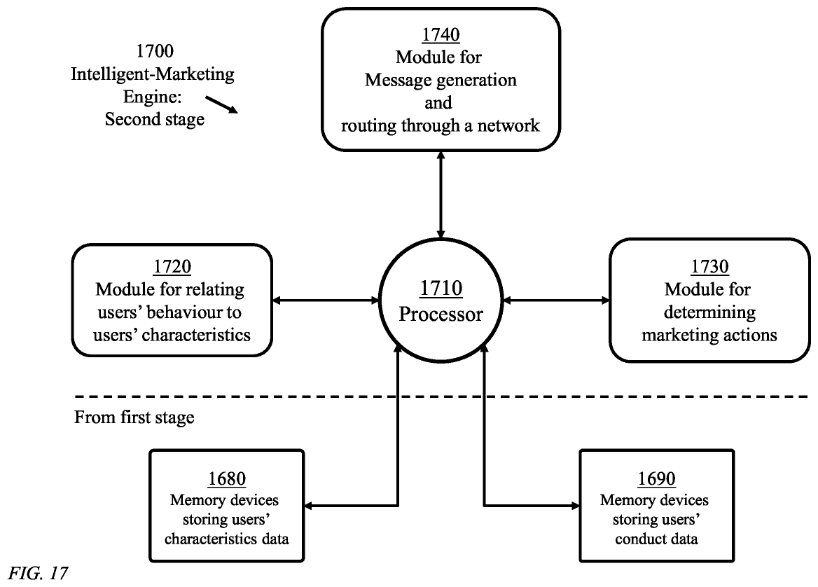

FIG. 2 illustrates an overview of a marketing function 200 based on trait-character linkage of users of a universe 210 of users. A marketing engine illustrated in FIG. 16 and FIG. 17 implements marketing function 200.

The term ‘user’ refers to a member of a specific population, such as participants of social networks. Information 220 characterizing a first plurality of tracked users of the universe of users 210 is acquired and the first plurality of tracked users is segmented accordingly into clusters 240 of users where members of a cluster have close characteristics which are distinct from characteristics of all other clusters. Information 230 relevant to behaviour (conduct) of a second plurality of tracked users of the universe 210 of users is acquired. The first plurality of users and the second plurality of users may overlap or even coincide. While a user belongs to a single cluster based on the user's characterizing information (hence the clusters of users do not have common users), users of different clusters may have common behaviour (conduct) attributes as illustrated in FIGS. 25 to 27. User-behaviour information 230 and the membership of the clusters 240 of users may be used to determine clusters-behaviour relationships (250).

It is important to distinguish characteristics of user from metrics of the user. The characteristics of a user represent slowly-varying properties (such as annual income), quasi-permanent properties (such as height of an adult), and/or permanent characteristics such as place of birth. The metrics of a user represent evolving properties, such as favourite entertainment or sport. The characteristics of a user may comprise numerous attributes represented as a vector. For marketing purposes, numerous metrics may be of interest and for a specific metric, or a specific set of metrics, it is desirable to determine saturation of the specific metric, or the specific set of metrics, within each cluster to establish clusters-metrics relationships (characteristics-behaviour association 250). Conversely, each cluster may be associated with a set of dominant metrics. Data triggering marketing actions 260 is generated based on clusters-metrics relationships and clusters' membership 240.

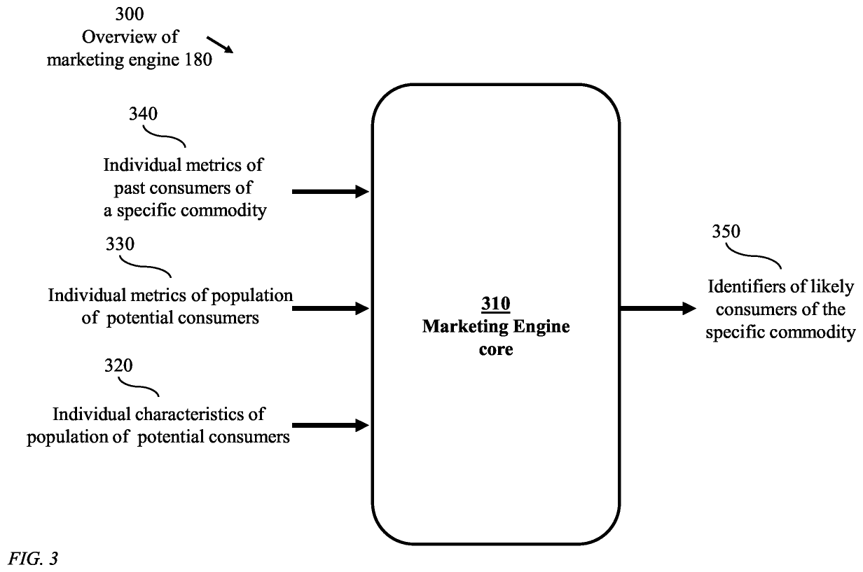

FIG. 3 illustrates an overview 300 of a marketing engine 180. Generally, inputs to the marketing-engine core 310 include individual consumer characteristics 320 of a first population of potential consumers, individual consumer metrics 330 of a second population of potential consumers, and individual consumer traits 340 of past consumers (seed users) of a specific commodity. The first population and second population belong to the universe 210 of users and may overlap or coincide. The marketing engine 180 produces identifiers 350 of likely consumers of the specific commodity.

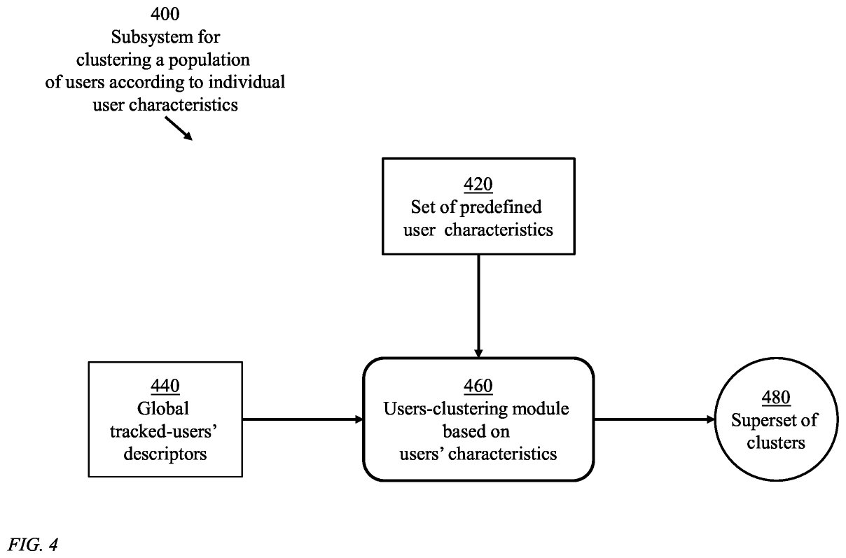

FIG. 4 illustrates components of a subsystem 400 for clustering the first population of users according to individual user characteristics. Given a set 420 of predefined user characteristics and descriptors 440 of tracked users, a module 460 segments the tracked users into clusters based on the set 420 of predefined user characteristics. The number of clusters may be prescribed or determined automatically. The produced clusters 480 are herein referenced as a superset of clusters from which a set of “distinct clusters” or a set of “target clusters” may be identified as will be described below. Generally, a user may be characterised according to a superset of descriptors relating to several properties of the user. The clustering process may, however, be based on a set of predefined characteristics comprising selected descriptors. For example, the superset of descriptors may include the gender of a user but the clustering process may not consider gender as a relevant characteristic.

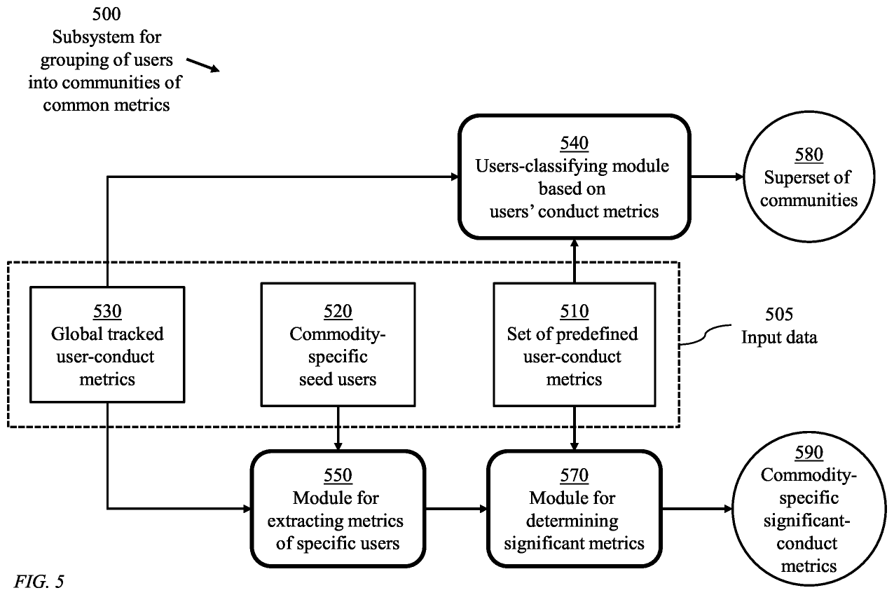

FIG. 5 illustrates components of a subsystem 500 for grouping users into communities according to individual user metrics or traits. As defined above, metrics of a user represent evolving user properties, such as societal views, favourite entertainment or sport, etc. A metric determined to be significant according to some criteria is labeled a “trait” of the user.

Input data of subsystem 500 comprises:
a set 510 of predefined (user-conduct) metrics;
a set 520 of commodity-specific seed users; and
global user-conduct metrics 530 of all tracked users.

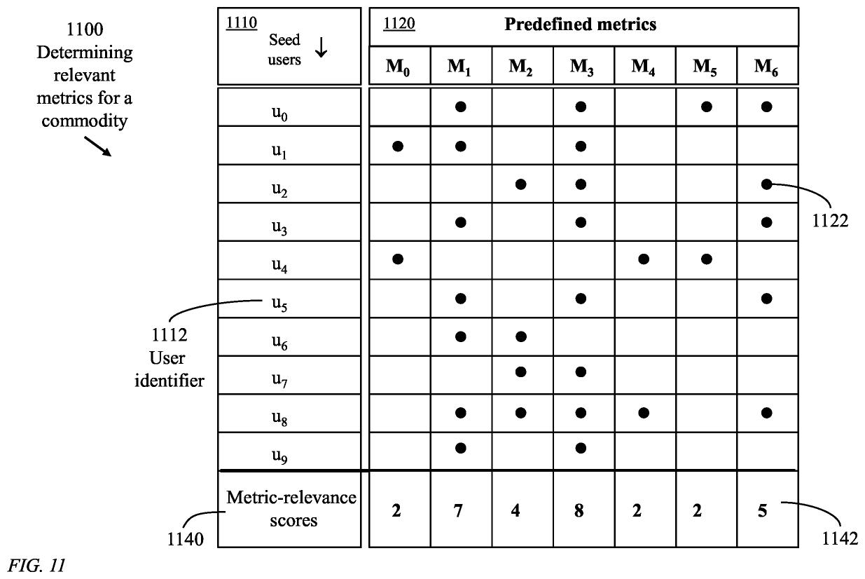

A module 540 classifies users of the second population of users according to the metrics, to produce a superset 580 of communities where users belonging to a community have a common metric. A module 550 extracts metrics of seed users from the global user-conduct metrics 530. As defined above, seed users are past consumers of a specific commodity that belong to the universe 210 of users under consideration. A module 570 identifies significant metrics 590 of the commodity-specific seed users. FIG. 11 illustrates a method of determining significant metrics relevant to a specific commodity.

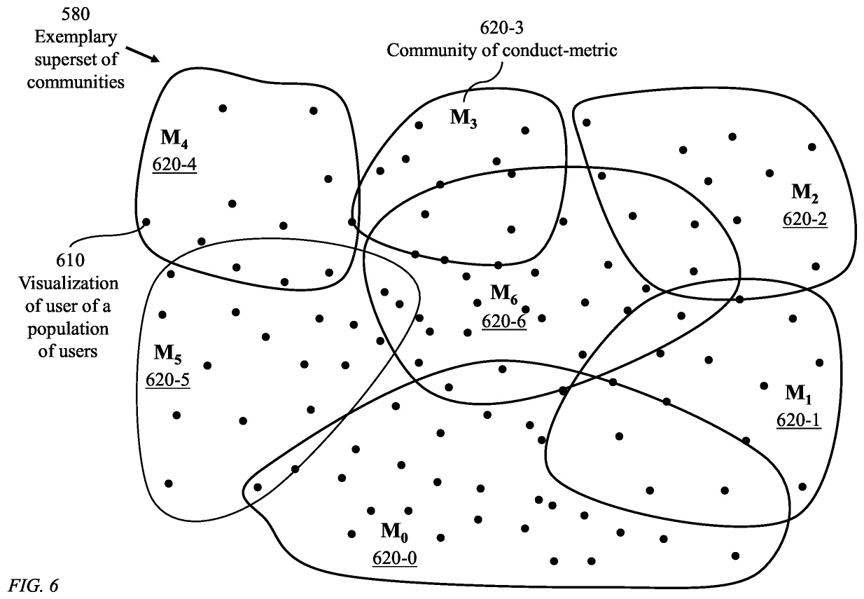

FIG. 6 illustrates an exemplary superset 580 of communities 620 of users of the second population of users, individually identified as 620(0), 620(1), 620(2), 620(3), 620(4), 620(5), and 620(6), determined according to seven metrics denoted M₀, M₁, M₂, M₃, M₄, M₅, and M₆, respectively. In the illustrated example, the second population of users overlaps the first population of users.

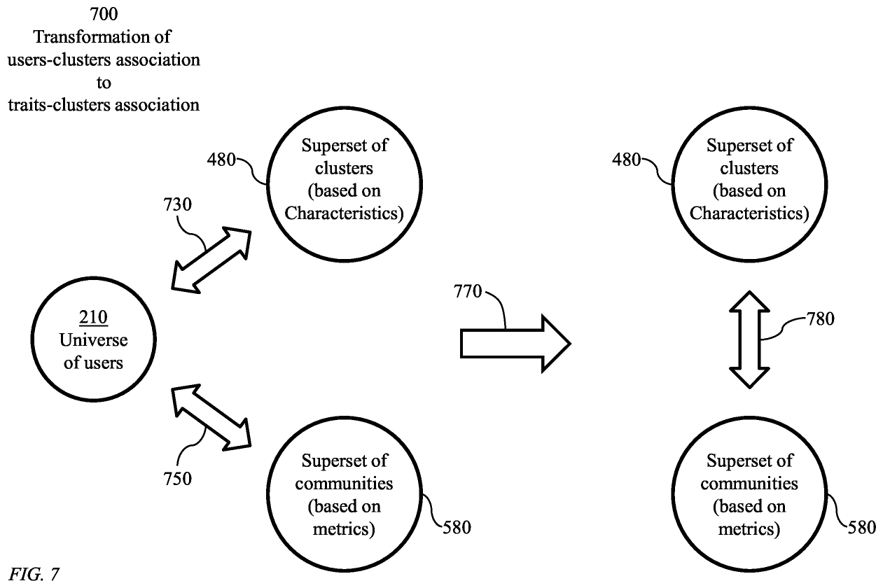

FIG. 7 illustrates a process 700 of transforming users' association with clusters and communities to metric-cluster association. Process 730 segments the first population of users according to individual user characteristics to produce a superset of clusters (using module 460, for example). Process 750 classifies the second population of users according to individual user metrics to produce a superset of communities (using module 540, for example). Process 770 establishes direct association 780 of metrics with clusters based on metric saturation within clusters, as described below with reference to FIG. 9, to supersede indirect linkage of clusters to metrics. The direct association 780 is realized through common users of the first population and the second population as detailed below with reference to FIG. 25, FIG. 26, and FIG. 27. In other words, the direct association is based on the intersection of the superset 580 of communities and the superset 480 of clusters.

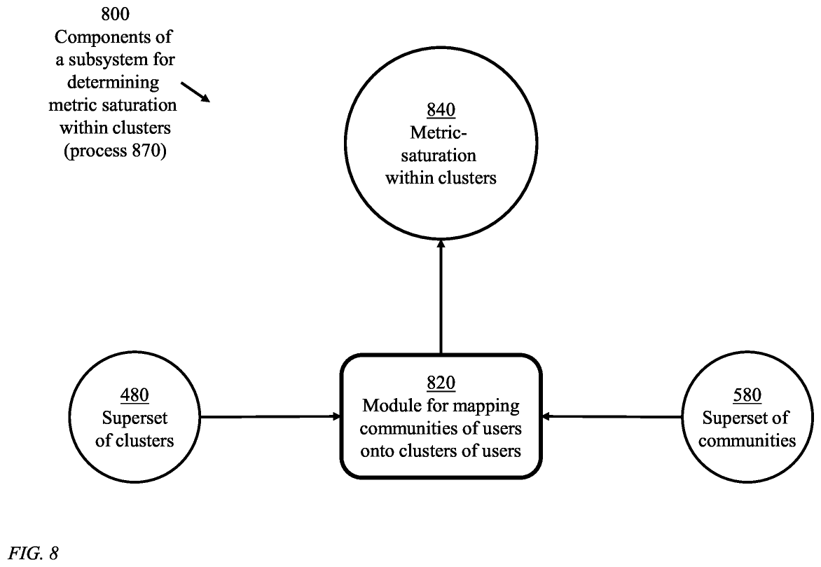

FIG. 8 illustrates components 800 of a subsystem for determining metric-saturation levels within clusters (process 770, FIG. 7). Module 820 maps communities of users of common metrics onto clusters of users to determine metric saturation levels 840 within clusters as detailed in FIGS. 25 to 27.

FIG. 9 illustrates a method 900 of determining metric-saturation levels within clusters. Process 910 acquires individual user characteristics. Process 920 generates a superset of clusters.

Process 930 acquires individual user metrics. Process 940 merges relationships of users to metrics with relationships of users to clusters to determine a saturation level of each metric within each cluster (FIG. 8). Process 950 determines a significance level of each metric according to respective metric saturation levels within each cluster of the superset of clusters as described below with reference to FIG. 25 and FIG. 26. Process 960 stores saturation levels of significant metrics.

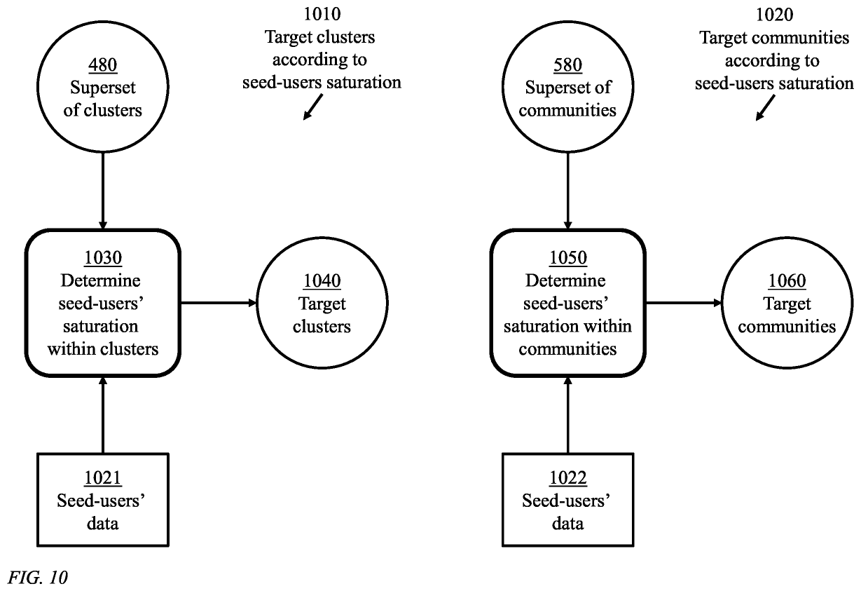

FIG. 10 illustrates components 1010 of a first subsystem for determining target clusters according to seed-users saturation within clusters for a specific commodity and components 1020 of a second subsystem for determining target communities according to seed-users saturation within communities for a specific commodity.

Process 1030 uses data 1021 relevant to acquired characteristics of seed users to determine seed-users' saturation within the superset 480 of clusters. A set 1040 of target clusters is then selected from the superset 480 of users according to levels of seed-users' saturation within individual clusters.

Process 1050 uses data 1022 relevant to acquired metrics of seed users to determine seed-users' saturation within the superset 580 of communities. A set 1060 of target communities is then selected from the superset 580 of communities according to levels of seed-users' saturation within individual communities.

FIG. 11 illustrates a process 1100 of determining relationship of individual commodities of interest to communities of the superset 580 of communities. Individual metrics, of a predefined set 1120 of metrics relevant to a specific commodity are identified based on metrics of individual seed users of an acquired set of seed users. In the illustrated example, ten seed users 1112, labeled u₀ to u₉ are considered. The predefined metrics are denoted M₀, M₁, M₂, M₃, M₄, M₅, and M₆. Metrics relevant to each seed user 1112 of a set 1110 of seed users are extracted from information 230 (FIG. 2) relevant to conduct (behaviour) of the second plurality of tracked users of the universe 210 of users. For each seed user 1112, relevant metrics are identified (indications 1122). Metrics M₁, M₃, M₅, and M₆ are attributed to user u₀, metrics M₀, M₁, and M₃ are attributed to user u₁, and metrics M₂ and M₃ are attributed to user u₇.

Metric-relevance scores 1140 are determined for the entire set of seed users. A score 1142 of relevance of a specific metric to the specific commodity is determined based on relevant metrics for each seed user. The scores of metrics M₀ to M₆ are 2, 7, 4, 8, 2, 2, and 5. A metric having a score 1142 exceeding a predefined threshold is considered a significant metric for the specific commodity. The predefined threshold may be set as a proportion of the total number of seeds users of the set of seed users. The ratios of scores of metrics M₀ to M₆ to the total number of seed users are 0.2, 0.7, 0.4, 0.8, 0.2, 0.2, and 0.5. Selecting a threshold of 0.42, for example, only metrics M₁, M₃, and M₆ would be considered significant metrics for the specific commodity.

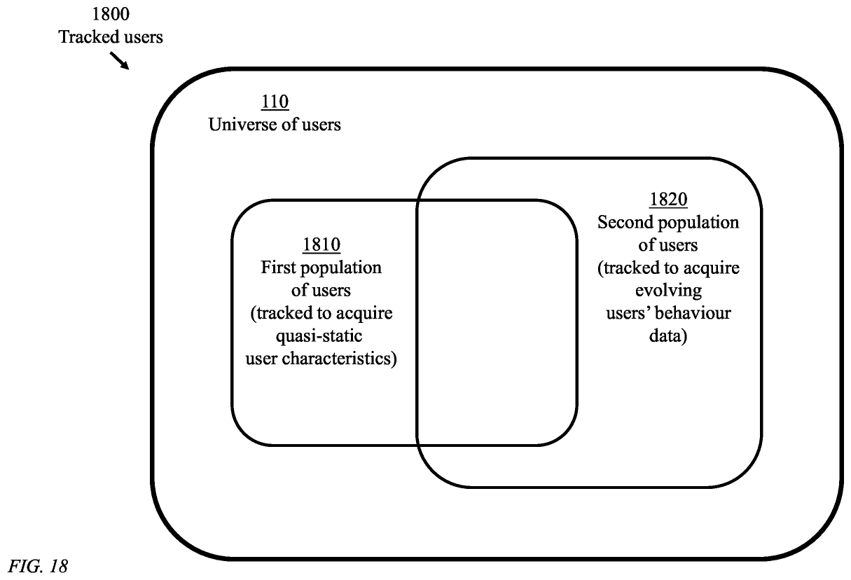

The universe 210 of users contains a first population of users for which characteristics of individual users are known and an overlapping second population of users for which metrics of individual users are known as illustrated in FIG. 18 below.

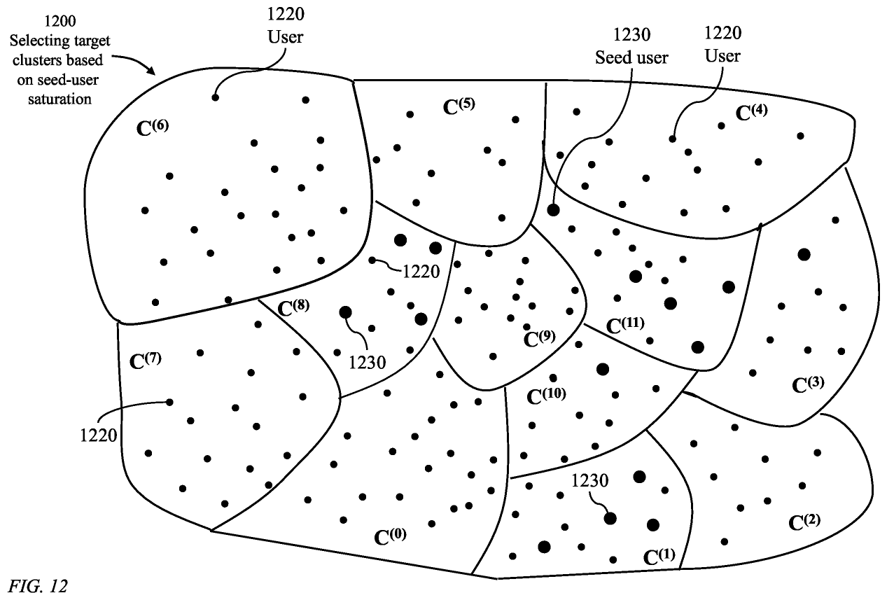

FIG. 12 illustrates a visualization 1200 of a process of selecting target clusters 1040 (FIG. 10) based on saturation levels of seed users within the superset 480 of clusters. An exemplary superset 480 of clusters comprises twelve clusters of users, of the first population of users, individually labeled C⁽⁰⁾, C⁽¹⁾, . . . C⁽¹¹⁾, formed according to users' characteristics. Visualization 1220 or 1230 of a user corresponds to a simplified two-dimensional vector of user characteristics. Generally, the vector of user characteristics is n-dimensional with n>1; n may be significantly larger than 1. Seed users of a specific commodity, defined as past consumers of the commodity, are individually referenced as 1230. Clusters C⁽¹¹⁾, C⁽¹⁾, C⁽⁸⁾, C⁽³⁾, and C⁽¹⁰⁾ contain 5, 4, 4, 1, and 1 seed users, respectively. A cluster with a seed-user saturation level exceeding a predefined threshold may be considered a target cluster for the commodity under consideration. The seed-user saturation level of a cluster is preferably prorated to the size of the cluster. Table-1 below indicates for each cluster a respective number of users (cluster size), a respective number of seed users (seed-user saturation score), and a ratio of the number of seed users to cluster size. A cluster size includes all users associated with a cluster including seed users.

For a threshold of 0.30, for example, of relative-saturation level, clusters C⁽¹⁾, C⁽⁸⁾, and C⁽¹¹⁾ would be selected as target clusters 1040.

TABLE I
Seed-user saturation within clusters

| Clusters | C⁽⁰⁾ | C⁽¹⁾ | C⁽²⁾ | C⁽³⁾ | C⁽⁴⁾ | C⁽⁵⁾ | C⁽⁶⁾ | C⁽⁷⁾ | C⁽⁸⁾ | C⁽⁹⁾ | C⁽¹⁰⁾ | C⁽¹¹⁾ |
|---|---|---|---|---|---|---|---|---|---|---|---|---|
| Cluster size | 21 | 12 | 9 | 9 | 15 | 9 | 22 | 16 | 10 | 14 | 11 | 14 |
| Saturation | 0 | 4 | 0 | 1 | 0 | 0 | 0 | 0 | 4 | 0 | 1 | 5 |
| score | | | | | | | | | | | | |
| Relative | 0.0 | 0.33 | 0.0 | 0.11 | 0.0 | 0.0 | 0.0 | 0.0 | 0.40 | 0.0 | .09 | 0.36 |
| saturation | | | | | | | | | | | | |

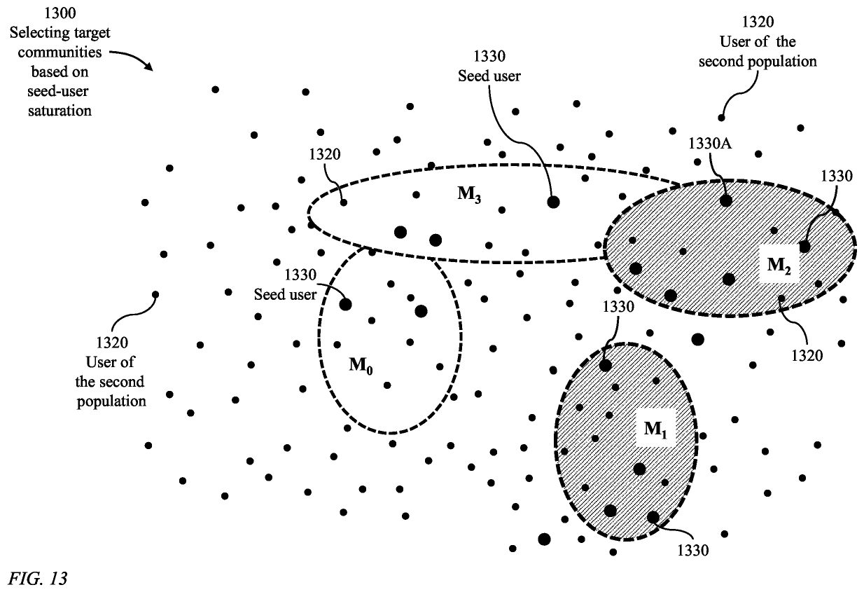

FIG. 13 illustrates a visualization 1300 of a process of selecting target communities 1060 (FIG. 10) based on saturation levels of seed users within the superset 580 of communities. Communities of users of the second population of users may be formed according to users' metrics. Only communities, labeled M₀, M₁, M₂, and M₃, containing seed users 1330 are illustrated. Visualization 1320 or 1330 of a user corresponds to a simplified two-dimensional vector of user metrics. Generally, the vector of user metrics is m-dimensional with m>1; m may be significantly larger than 1.

A user 1220 or a seed user 1230 belongs to the first population of users and may also belong to the second population of users. A user 1320 or a seed user 1330 belongs to the second population of users and may also belong to the first population of users.

Communities M₀, M₁, M₂, and M₃ contain 2, 4, 5 and 3 seed users, respectively. A community with a seed-user saturation level exceeding a predefined threshold may be considered a target community for the commodity under consideration. The seed-user saturation level of a community is preferably prorated to the size of the community. With communities M₀, M₁, M₂, and M₃, containing 10, 12, 10, and 11 users, respectively, the prorated saturation levels are 0.2, 0.33, 0.50, and 0.27, respectively. For a threshold of 0.30, for example, of relative-saturation level, communities of metrics M₁ and M₂, would be selected as target communities 1060.

The target clusters 1040, the target communities 1060, or the union of the target clusters and target communities may be selected as potential consumers for the specific commodity under consideration.

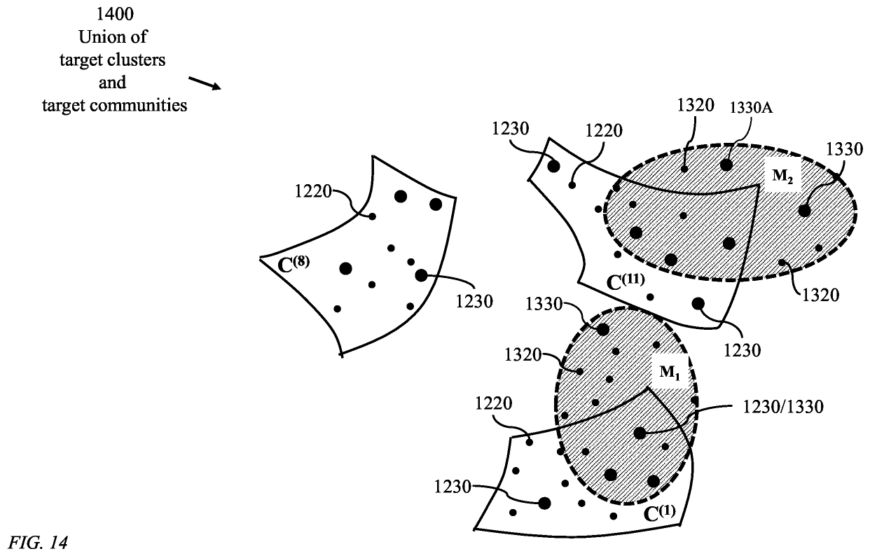

FIG. 14 illustrates a union 1400 of target clusters C⁽¹⁾, C⁽⁸⁾ and C⁽¹¹⁾ and target communities of metrics M₁ and M₂. As illustrated, cluster C⁽¹⁾ intersects the community of metric M₁ and cluster C⁽¹¹⁾ intersects the community of metric M₂. In general, the target clusters 1040 and the target communities may not intersect.

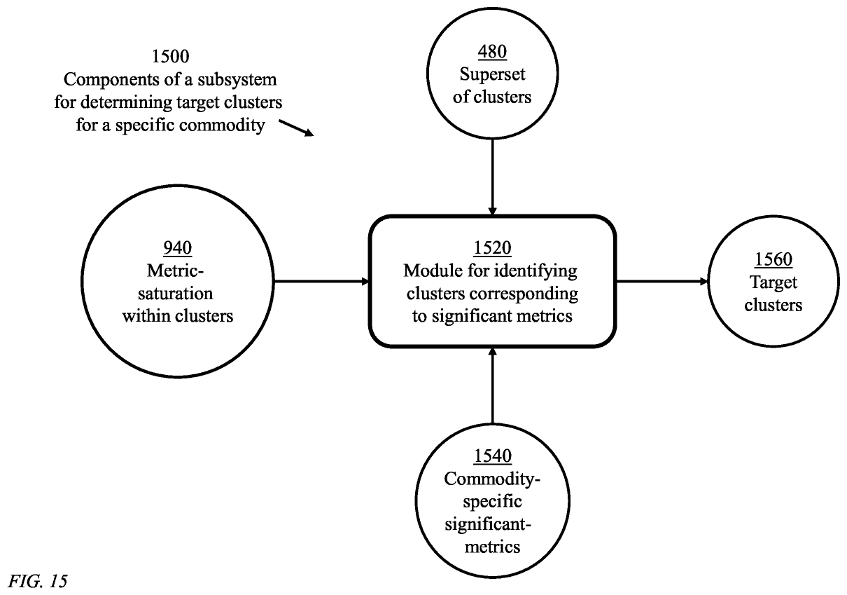

FIG. 15 illustrates components 1500 of a second subsystem for determining target clusters for a specific commodity according to metrics saturation levels within clusters and metrics relevant to a specific commodity. A module 1520 identifies a set 1560 of target clusters, selected from the superset 480 of clusters, for the specific commodity according to:
(i) matric saturation 840 (FIG. 8) within individual clusters of the superset 480 of clusters; and
(ii) significant metrics 1540 of the set of seed users with respect to a specific commodity.

The significant metrics 1540 relevant to the specific commodity are metrics having a score 1142 (FIG. 11) exceeding a predefined threshold as described above.

FIG. 16 illustrates an apparatus 1600 constituting a first stage of an intelligent marketing engine. Apparatus 1600 comprises a processing assembly 1620 which may be configured as multiple hardware processors operating concurrently in a parallel arrangement, a pipelined arrangement, or a combined parallel-pipelined arrangement. Apparatus 1600 further comprises a plurality of memory devices for storing software modules, acquired input data and generated intermediate data.

Each software module comprises processor-executable instructions which cause a hardware processor to implement respective functions. The modules comprise:
a network interface 1610 for acquisition of data relevant to a plurality of tracked users;
a module 1630 for acquisition of apparatus customization data from an administrator of the marketing engine;
a module 1640 for acquisition of users' characterization data from a first plurality of users;
a module 1650 for segmenting the first plurality of users into clusters according to users' characterization data;
a module 1660 for acquisition of users' metrics representing conduct data (behaviour data) of a second plurality of users; and
a module 1670 for determining distinctive metrics and corresponding sets of users or corresponding clusters of users.

A set 1680 of memory devices store users' characterization data and content of the clusters of users resulting from the segmentation processes of module 1650.

A set 1690 of memory devices store users' metrics determined in module 1660 as well as distinctive metrics of each cluster as determined in module 1670.

FIG. 17 illustrates an apparatus 1700 constituting a second stage of the intelligent marketing engine. Apparatus 1700 comprises a processing assembly 1710, which may be configured as multiple hardware processors, coupled to a memory device storing a module 1720 for determining relationships of users' conduct to characteristics, a memory device storing a module 1730 for determining marketing actions based on conduct-characteristics linkage; and a memory device storing a module 1740 for message generation and routing data through a network. The processing assembly 1710 is coupled to the sets of memory devices 1680 and 1690 storing output data of apparatus 1600. FIG. 29 and FIG. 38 illustrate details of exemplary implementations of module 1720.

FIG. 18 illustrates a visualization 1800 of tracked users of the universe 210 of users (FIG. 2). Users are tracked to acquire respective characteristics and/or metrics. Equivalently, a first plurality 1810 of users may be tracked to acquire quasi-static user characteristics and a second plurality 1820 of users may be tracked to acquire current users' conduct data. The second plurality 1820 of users may overlap the first plurality 1810 of users.

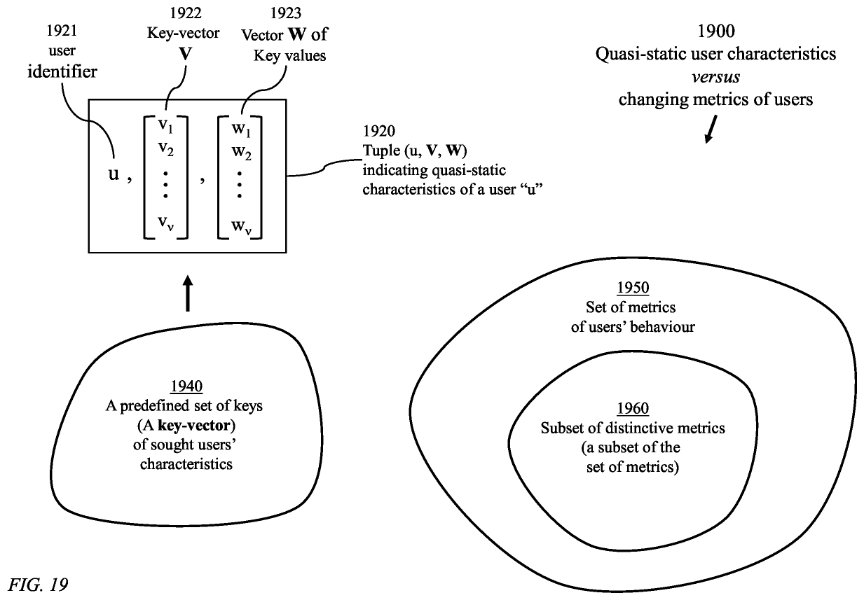

FIG. 19 illustrates a representation 1900 of quasi-static users' characteristics versus evolving metrics of users' conduct. A set 1940 of predefined key-vectors of users' characteristics is predefined. A tuple {u, V, W} indicates quasi-static characteristics 1920 of a user where “u” is a scalar 1921 identifying the user, V is a Key-vector 1922 of ν elements each identifying a variable, and W is a vector 1923 of ν values having a one-to-one correspondence to the ν variables, ν>1. A set 1950 of metrics identifying users' conduct is also predefined. A subset 1960 of the set 1950 of metrics containing metrics determined to be significant is to be determined.

Significant metrics are referenced as “traits”.

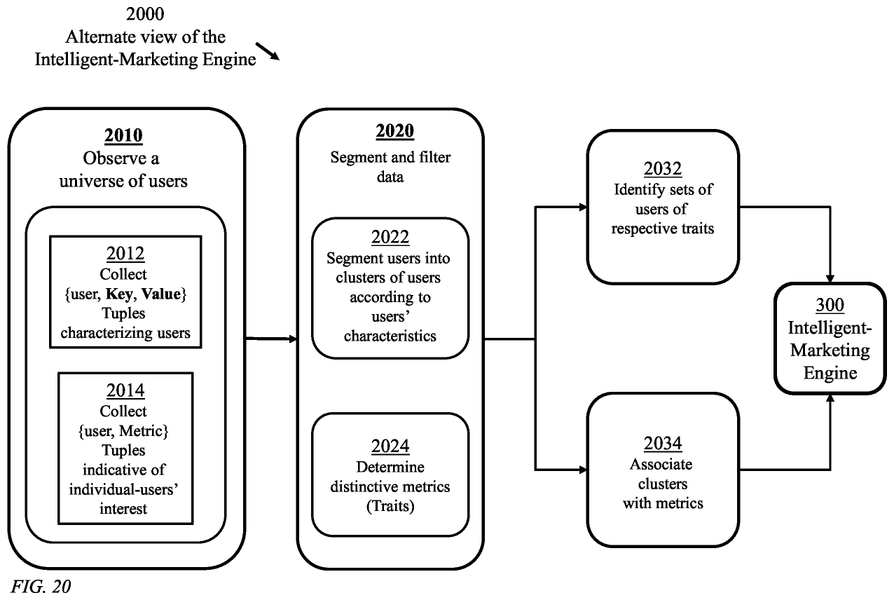

FIG. 20 illustrates an alternate view 2000 of the first stage of the intelligent marketing engine of FIG. 16. The engine comprises a module 2010 for observing the universe 210 of users, a module 2020 for segmenting users and filtering metrics to retain distinctive metrics (traits), a module 2032 for identifying sets of users of respective similar metrics, and a module 2034 for associating clusters with respective metrics. Module 2010 comprises processor-executable instructions 2012 for collecting tuples 1920 and processor-executable instructions 2014 for collecting metrics 1950. Module 2020 comprises processor-executable instructions 2022 for segmenting users into clusters and processor-executable instructions 2024 for filtering metrics to retain distinctive metrics.

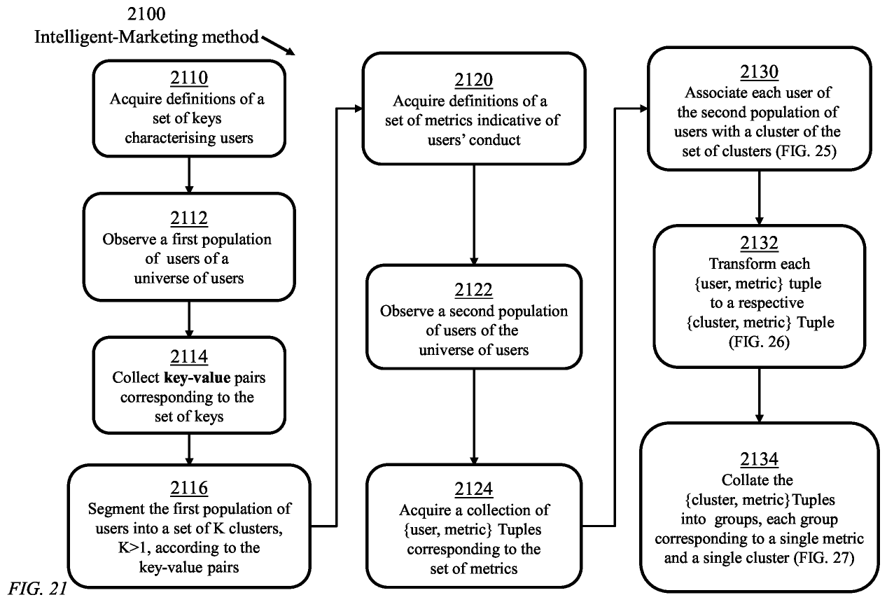

FIG. 21 illustrates a method 2100 for intelligent marketing. The method executes process 2110 to 2134 as described below.

Process 2110 acquires definitions of a set of key-vectors characterizing users. Process 2112 observes the first plurality of users of the universe of users 210. Process 2114 collects key-value pairs for detected users' activities. Process 2116 segments the first plurality of users into K clusters according to the collected key-value pairs, K>1. The number K of clusters may be predefined or determined automatically according to the applied method of clustering. Process 2120 acquires definitions of a set of metrics indicative of users' conduct (behaviour) Process 2122 observes the second plurality of users of the universe of users 210. Process 2124 acquires a collection of {user-metric} tuples corresponding to the set of metrics. Process 2130 relates each user of the second plurality of users to a cluster of the generated set of clusters. Process 2132 transforms the {user, metric} tuples to {cluster, metric} tuples (an implementation of process 770, FIG. 7). Process 2134 collates {cluster, metric} tuples into groups (incidences) each group corresponding to a single metric and a single cluster.

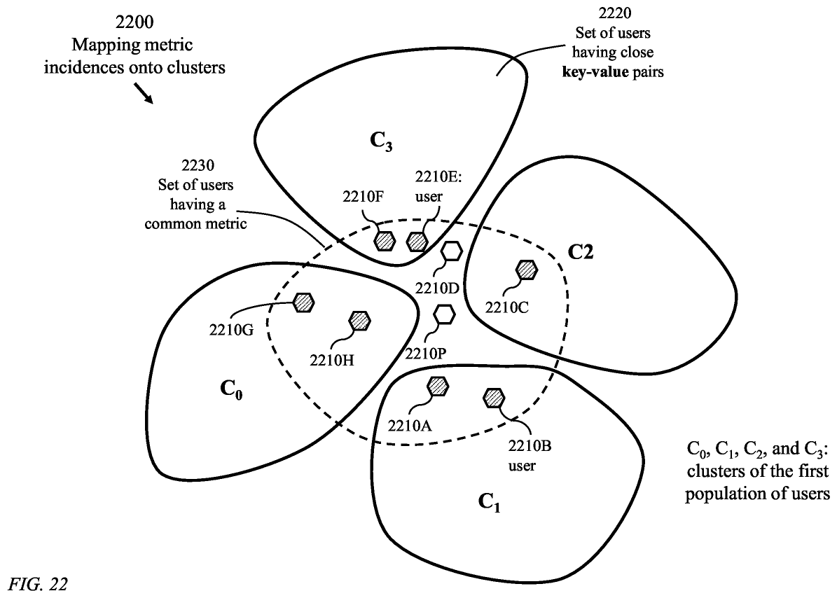

FIG. 22 visualizes a process 2200 of mapping metric incidences onto clusters. Users of the first plurality of users are segmented into clusters according to mutual affinity. Thus, users of close key-value pairs are associated with a respective cluster 2220. Four clusters C₀, C₁, C₂, and C₃ of users are illustrated.

A community 2230 of nine users 2210 of a common metric (common interest/common behaviour) is illustrated. Each of users 2210A, 2210B, 2210C, 2210E, 2210F, 2210G, and 2210H belongs to both the first plurality of users and the second plurality of users. Users 2210G and 2210H belong to a cluster C₀, users 2210A and 2210B belong to a cluster C₁, user 2210C belongs to a cluster C₂, and users 2210E and 2210F belong to a cluster C₃. Users 2210D and 2210P belong to the second plurality of users but not the first plurality of users. Thus, neither 2210D nor 2210P is assigned to any of clusters C₀, C₁, C₂, and C₃.

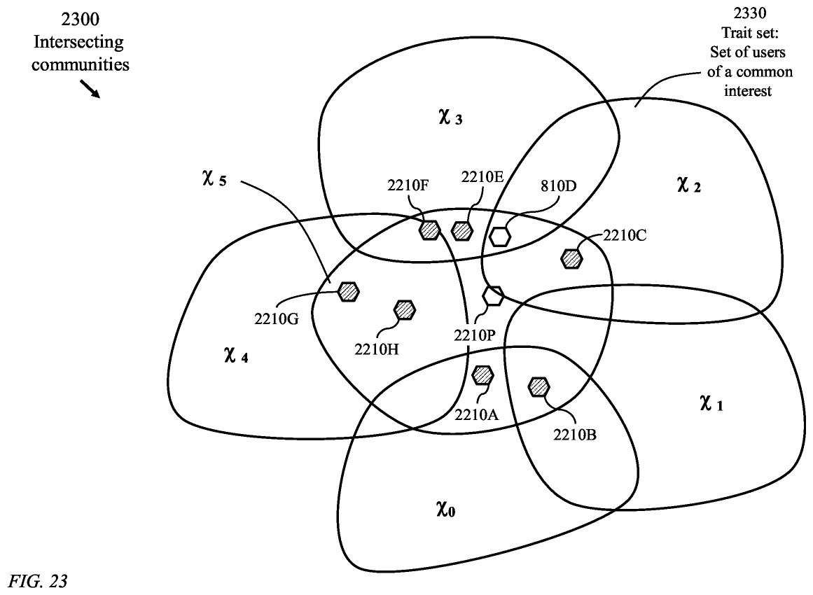

FIG. 23 illustrates a visualization 2300 of intersecting communities 2330, each community comprising a set of users of a common metric. Six communities 2330 labeled χ₀, χ₁, χ₂, χ₃, χ₄, and χ₅ are illustrated. A user may have multiple metrics; for example, user 2210A belongs to communities χ₀ and χ₅, user 2200G belongs to χ₄ and χ₅, and user 2210D belongs to χ₂, χ₃, and χ₅.

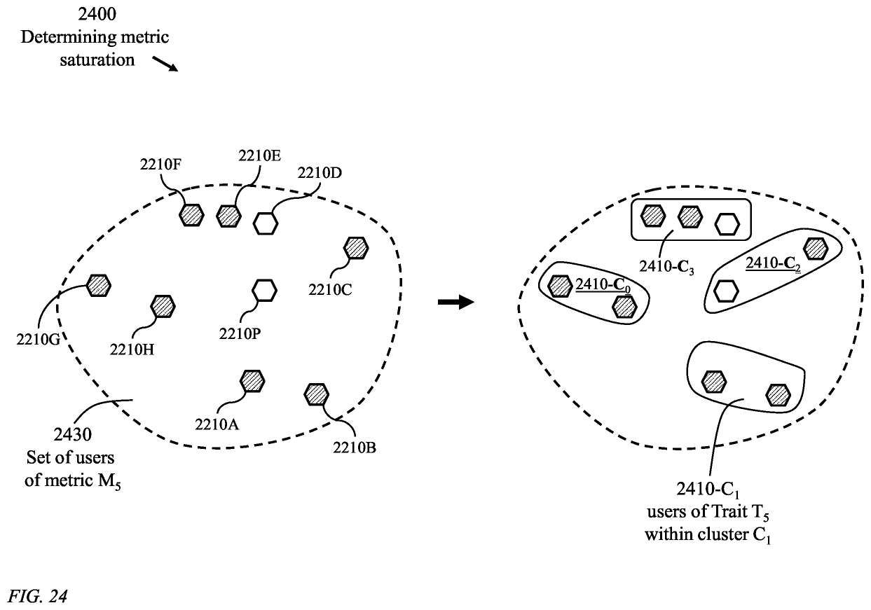

FIG. 24 visualizes a process 2400 of determining metric saturation within clusters. The set 2430 of users 2210 of the community χ₅ of FIG. 22 comprises nine users 2210 of which two users 2210D and 2210P belong to the second plurality of users but not the first plurality of users, The seven users which belong to both the first population and second population of users are separated into cluster-saturation subsets 2410, each subset belonging to a respective cluster. Subset 2410-C₀ comprises users 2210G and 2210H which belong to cluster C₀ (FIG. 22). Subset 2410-C₁ comprises users 2210A and 2210B which belong to cluster C₁ (FIG. 22). Subset 2410-C₂ comprises only user 2210C which belongs to cluster C₂. Subset 2410-C₃ belongs to cluster C₃ and comprises users 2210E and 2210F.

FIG. 25 illustrates a process 2500 relating users to clusters and users to metrics indicating users' interests. The process may be implemented in module 820 (FIG. 8). The first population of users is segmented into clusters 2520. Four clusters 2520(0), 2520(1), 2520(2), and 2520(3) are illustrated. A set 2510 comprises users that were tracked to capture metrics indicating respective behaviour. As such, the tracked users belong to the second plurality of users. Set 2510 may include the entire second population of users.

However, some, or all, of the tracked users may also belong to the first plurality of users and hence can be associated with respective clusters. If a user of the second plurality of users is not a member of a cluster, characteristics of the user, i.e. tuple {u, V, W} of FIG. 19, may be acquired to enable associating the user with an appropriate cluster. If the characteristics are not available, the user and respective metric are not taken into consideration. FIG. 25 illustrates two users 2512 the characteristics of which are not available.

The objective of process 2500 is to determine saturation of each metric of a set of predefined metrics 2525 (relevant to interests, conduct, . . . ) within each cluster 2520. As mentioned above, a user may have multiple metrics. Conversely, multiple users may have a common metric. For each metric 2525, a bundle 2540 of associated users which may belong to different clusters are determined. Thus, the saturation of each metric within each cluster may be determined. A metric that satisfy a number of conditions may be qualified as a “trait” of a cluster. One of the conditions is that the metric should be distinctive with a high saturation variance among the clusters. For example, metric 2525(4) has equal saturation levels within the four clusters. Hence, metric 2525(4) is not distinctive and would be deleted from the set of metrics.

FIG. 26 illustrates saturation 2600 of metrics within clusters. For each metric 2525 a number 1140 of instances of the metric within a specific cluster is determined. Metrics 2525(0), 2525(1), 2525(6), 2525(7), and 2525(8) are considered distinctive, based on variance of saturation within clusters 2520, and selected as traits 2630 labeled T₀, T₁, T₂, T₃, and T₄.

FIG. 27 illustrates trait saturation 2700 within clusters. A number 2740 of instances of each trait within a specific cluster is indicated. In the illustrated example, two users in cluster C₀ and one user in cluster C₁ possess trait T₀, two users in cluster C₁, two users in cluster C₂, and one user in cluster C₃ possess trait T₂.

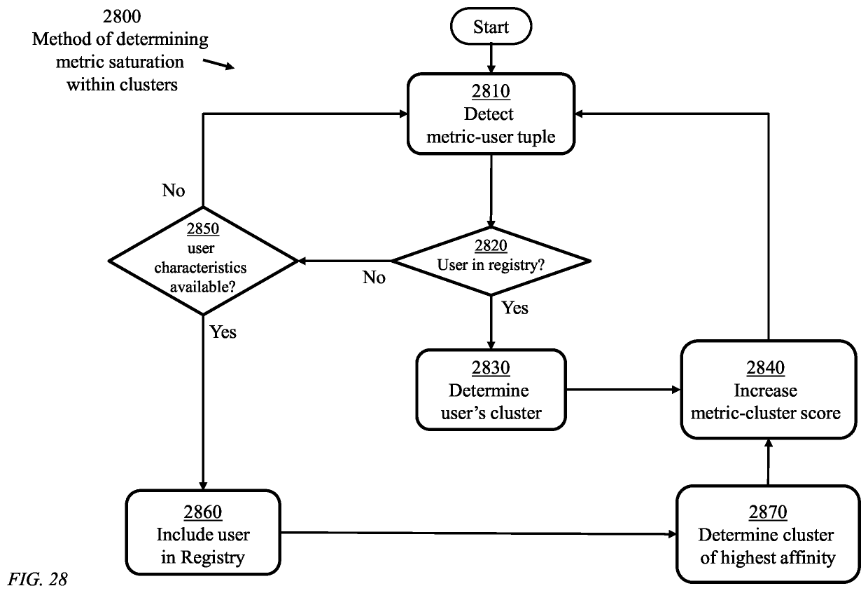

FIG. 28 illustrates a method 2800 of determining metric saturation within clusters. The method relies on employing known techniques of monitoring users (such as participants of a social networks) to detect users' conduct. A user's conduct is expressed as a metric of a predefined set of metrics. A registry of known users that have been segmented into a set of K clusters of users, K>1, is maintained. Segmentation of users into clusters is based on individual characteristics (properties) of the users. The objective of the method is to collect and continually update metric saturation levels within each of the clusters. A metric-saturation level of a specific metric within a cluster is determined as a score of users possessing the specific metric. A data structure (such as a matrix) is formulated to hold metric-cluster scores.

To start, a metric-user tuple indicating an identity of a user and a corresponding metric is detected (process 2810). Process 2820 determines whether the user is already present in the registry. If so, process 2830 determines a cluster to which the user belongs, process 2840 increases the cluster-metric score, and process 2810 is revisited to detect a new metric-user tuple. If process 2820 determines that the user is unknown (not indicated in the registry), process 2850 attempts to obtain characteristics (properties) of the user to enable associating the user with an appropriate cluster. If such characteristics are available, process 2860 includes the (unknown) user in the registry and process 2870 determines a specific cluster to which the user has the highest affinity in comparison with other clusters. Process 2840 increases the cluster-metric score and process 2810 is revisited. If process 2850 determines that the characteristics of the user are not available, no changes in the registry or any metric-cluster score take place and process 2810 is revisited.

FIG. 29 illustrates a first method 2900 of determining distinctive traits and corresponding sets of clusters (a second method is illustrated in FIG. 38). To start, process 2910 selects a metric of the set of metrics. Process 2920 determines metric saturation within each of K clusters, K>1, as described with reference to FIG. 25 and FIG. 26. Process 2925 initializes a set of candidate clusters as an empty set.

Process 2930 selects the K clusters, one at a time. Process 2940 determines the singularity of the metric. For cluster k, 0≤k<K, the singularity of the metric with respect to the cluster is determined as a ratio of the metric saturation level within cluster k to the mean saturation level of all other (K−1) clusters.

Process 2950 determines whether the ratio exceeds a predefine singularity threshold H. If the ratio exceeds the threshold H, process 2960 adds cluster k to the set of candidate clusters. Otherwise, process 2970 is activated. Process 2970 determines whether all of the K clusters have been considered. If so, process 2980 is activated. Otherwise, process 2930 is revisited.

Process 2980 determines whether the set of candidate clusters is still empty. An empty set results when the metric is not distinctive. If the set of candidate clusters is empty, process 2982 discards the metric as indistinctive and process 2910 is revisited to select a new metric, if any. If the set of candidate clusters contains an identifier of at least one cluster, process 2981 selects the metric as a trait and the saturation of the trait within each of the at least one cluster is recorded for further processing. Following process 2981, process 2910 is revisited to select a new metric, if any.

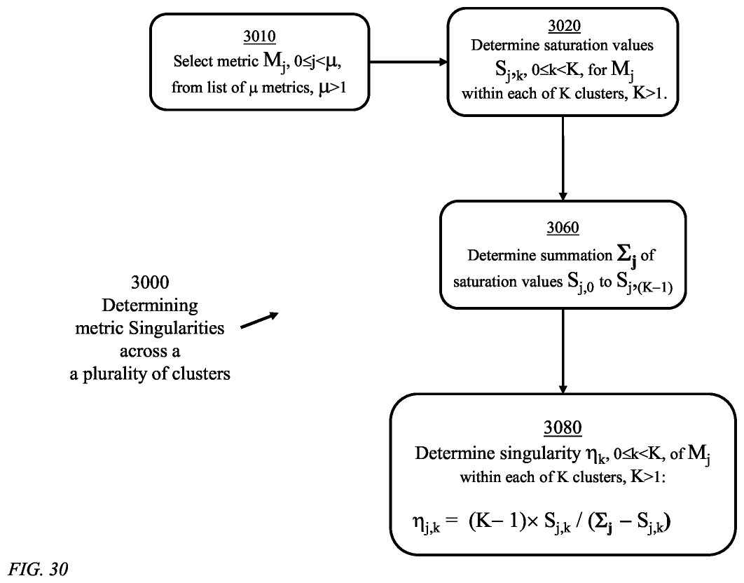

FIG. 30 illustrates a method 3000 of determining metric singularities within a set of K clusters, K>1. With a set of μ candidate metrics under consideration, μ>1, a metric Mⱼ is selected, 0≤j<μ (process 3010).

The singularity of the selected matric with respect to a cluster k, 0≤k<K, is determined based on the saturation score S_{j,k} of Mⱼ, which is the number of users of cluster k associated with metric Mⱼ. Process 3020 determines saturation values S_{j,k} of Mⱼ, 0≤k<K, within each of K clusters, and process 3060 determines a summation Σⱼ of saturation values S_{j,k}, 0≤k<K:

Σⱼ={S_{j,0}+S_{j,1}+ . . . +S_{j,(K-1)}}.

Process 3080 determines singularity η_{j,k}, 0≤k<K, of Mⱼ, within each of K clusters:

η_{j,k}=(K−1)×S_{j,k}/(Σⱼ−S_{j,k}).

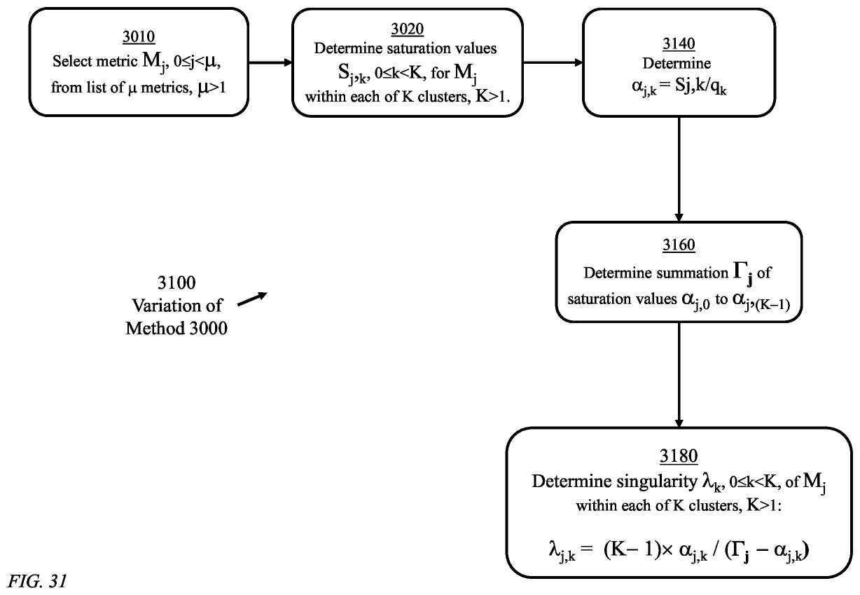

FIG. 31 illustrates a variant of method 3000 where the singularity is determined based on the relative saturation α_{j,k} of Mⱼ, 0≤k<K, which is the number S_{j,k} divided by the total number q of users of cluster k: α_{j,k}=S_{j,k}/qⱼ. Processes 3010 and 3020 have been described above with reference to FIG. 30. Process 3140 determines the number of users for each cluster and the relative saturation values.

Process 3160 determines a summation F of saturation values α_{j,k}, 0≤k<K:

Γⱼ={α_{j,0}+α_{j,1}+ . . . +α_{j,(K-1)}}.

Process 3180 determines singularity λ_{j,k}, 0≤k<K, of Mⱼ, within each of K clusters:

λ_{j,k}=(K−1)×α_{j,k}/(Γⱼ−α_{j,k}).

Thus, either η_{j,k} or λ_{j,k}, 0≤j<μ, 0≤k<K, is used as the ratio in process 2950 (FIG. 29).

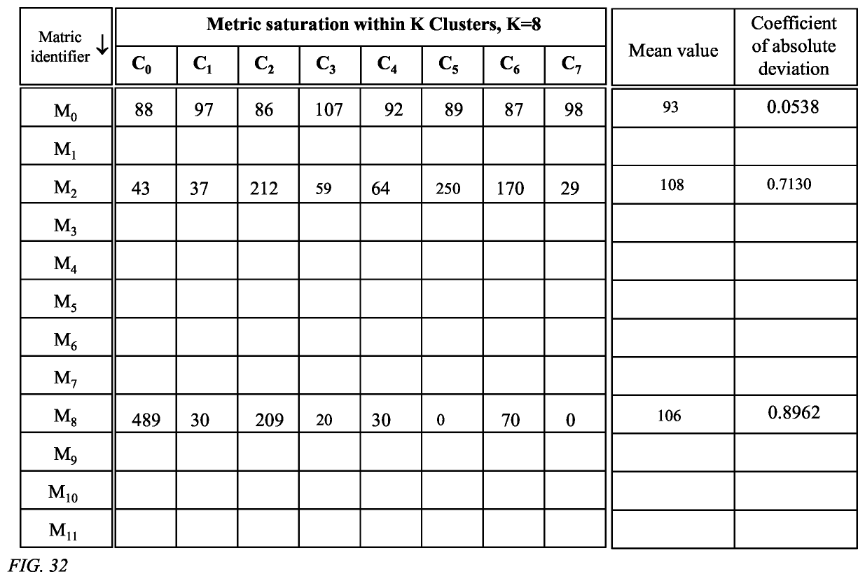

FIG. 32 illustrates determining metric saturations within different clusters. In the illustrated example, a first plurality of users is segmented into eight clusters labelled C₀ to C₇. An administrator of the marketing engine prescribes a set of metrics of interest indicating likely users' behaviour. Users of the second population of users are tracked to detect metrics indicating likely behaviour of individual users. As illustrated in FIG. 18, the first plurality of users and the second plurality of users may have common users. The saturation score of each metric of a preselected set of metrics, labelled M₀ to M₁₁, within each cluster is determined. Saturation scores for metrics M₀, M₂, and M₈ are indicated. The mean value of saturation scores for metrics M₀, M₂, and M₈ are determined as 93, 108, and 106, respectively. The corresponding coefficients of deviation, defined as the mean value of the magnitudes of score deviations from mean value are determined as 0.0538, 0.7130, and 0.8962.

To be considered distinctive, a metric should have a mean saturation score exceeding a first predefined threshold and a coefficient of inter-cluster deviation exceeding a second predefined threshold. With a second predefined threshold of 0.25, for example, metric M₀ would be considered indistinctive.

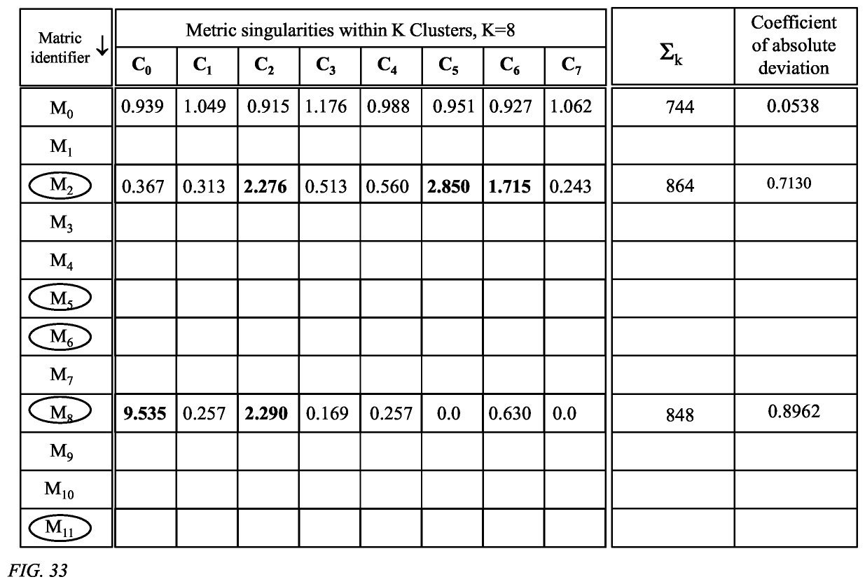

FIG. 33 illustrates metric singularities for each of metrics M₀, M₂, and M₈ within clusters C₀, C₁, . . . , C₇ determined according to expression 3080.

The metric saturation levels of FIG. 32 and the metric singularity values of FIG. 33 are based on clusters of equal sizes, i.e., the number of users per cluster is the same for all clusters. In general, the clusters' membership may differ significantly. Thus, the metric saturation levels within the clusters are preferably normalized.

Table-II below indicates, for Metric M₀, a community size, a saturation score, deviation of the saturation score from the mean value of 93 (FIG. 32), the relative saturation, and relative deviation for each cluster.

TABLE II
Metric M₀ saturation and singularity

| | Cluster Cₖ, cluster size Qₖ, 0 ≤ k < K, K = 8 | | | | | | | |
|---|---|---|---|---|---|---|---|---|
| Metric M₀ | 0 | 1 | 2 | 3 | 4 | 5 | 6 | 7 |
| saturation data ↓ | 600 | 740 | 600 | 800 | 500 | 600 | 460 | 700 |
| Saturation score S_{0, k} | 88 | 97 | 86 | 107 | 92 | 89 | 87 | 98 |
| Deviation Δ_{0, k} | −5 | 4 | −7 | 14 | −1 | −4 | −6 | 5 |
| Relative saturation α_{0, k} | 0.147 | 0.131 | 0.143 | 0.134 | 0.184 | 0.148 | 0.189 | .140 |
| Relative deviation δ_{0, k} | −.005 | −.021 | −.009 | −.018 | 0.032 | −.004 | 0.037 | −.012 |
| Singularity-1 η_{0, k} | 0.939 | 1.049 | 0.915 | 1.176 | 0.988 | 0.951 | 0.927 | 1.062 |
| Singularity-2 λ_{0, k} | 0.963 | 0.845 | 0.933 | 0.867 | 1.248 | 0.970 | 1.288 | 0.911 |

Sum of saturation values S_{0,0}+S_{0,1}+ . . . +S_{0,7}: 744
Mean saturation: 93
Sum of magnitudes of deviation |Δ_{0,0}|+|Δ_{0,1}|+ . . . +|Δ_{0,7}|: 46
Coefficient of deviation: 0.0618
Sum of relative saturation values α_{0,0}+α_{0,1}+ . . . +α_{0,7}: 1.216
Mean relative saturation: 0.152
Sum of magnitudes of relative deviation |δ_{0,0}|+|δ_{0,1}|+ . . . +|δ_{0,7}|: 0.138
Coefficient of relative deviation: 0.1135

As indicated in Table-II, singularity values η_{j,k}, 0<j<μ, 0≤k<K, based on raw saturation values (singularity-1) may differ significantly from corresponding singularity values λ_{j,k}, 0≤j<μ, 0≤k<K, based on relative (normalized) saturation values (singularity-2). With a relative inter-cluster deviation of 0.1135 (less than the threshold of 0.25), metric M₀ is considered indistinctive.

Table-III below indicates, for Metric M₂, a community size, a saturation score, deviation of the saturation score from the mean value of 108 (FIG. 32), the relative saturation, and relative deviation for each cluster.

TABLE III
Metric M₂ saturation and singularity

| | Cluster Cₖ, cluster size Qₖ, 0 ≤ k < K, K = 8 | | | | | | | |
|---|---|---|---|---|---|---|---|---|
| Metric M₀ | 0 | 1 | 2 | 3 | 4 | 5 | 6 | 7 |
| saturation data ↓ | 600 | 740 | 600 | 800 | 500 | 600 | 460 | 700 |
| Saturation S_{0, k} | 43 | 37 | 212 | 59 | 64 | 250 | 170 | 29 |
| Deviation Δ_{0, k} | −65 | −71 | 104 | −49 | −44 | 142 | 62 | −79 |
| Relative saturation α_{0, k} | 0.072 | 0.050 | 0.353 | 0.074 | 0.128 | 0.417 | 0.370 | .041 |
| Relative deviation δ_{0, k} | −.116 | −.138 | 0.165 | −.114 | −.060 | 0.229 | 0.182 | −.147 |
| Singularity-1 η_{0, k} | 0.367 | 0.313 | 2.276 | 0.513 | 0.560 | 2.850 | 1.715 | 0.243 |
| Singularity-2 λ_{0, k} | 0.352 | 0.241 | 2.145 | 0.362 | 0.651 | 2.683 | 2.282 | 0.196 |

Sum of saturation scores S_{0,0}+S_{0,1}+ . . . +S_{0,7}: 864
Mean saturation score: 108
Sum of magnitudes of deviation |Δ0,0|+|Δ_{0,1}|+ . . . +|Δ_{0,7}|: 616
Coefficient of absolute deviation: 0.7130
Sum of relative saturation values α_{0,0}+α_{0,1}+ . . . +α_{0,7}: 1.505
Mean relative saturation: 0.1881
Sum of magnitudes of relative deviation |δ_{0,0}|+|δ_{0,1}|+ . . . +|δ_{0,7}|: 1.151
Coefficient of deviation: 0.765

As indicated in Table-II, singularity values η_{j,k}, 0≤j<μ, 0≤k<K, based on raw saturation values (singularity-1) may differ significantly from corresponding singularity values λ_{j,k}, 0≤j<μ, 0≤k<K, based on relative (normalized) saturation values (singularity-2). With a relative inter-cluster deviation of 0.765 (greater than the threshold of 0.25), metric M₂ is considered distinctive.

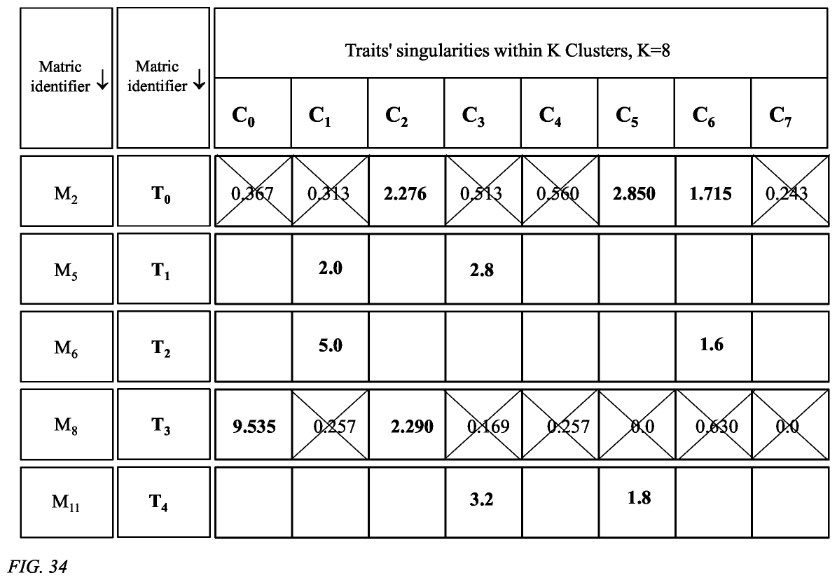

FIG. 34 illustrates trait singularities within different clusters. Applying the method of FIG. 29 and FIG. 30, metrics M₂, M₅, M₆, M₈, and M₁₁ are determined to be distinctive and, therefore, are selected as traits labeled T₀, T₂, T₂, T₃, and T₄, respectively. A metric is considered significant if the metric's singularity within at least one cluster exceeds a predefined singularity threshold H. In the example of FIG. 34, H=1.4.

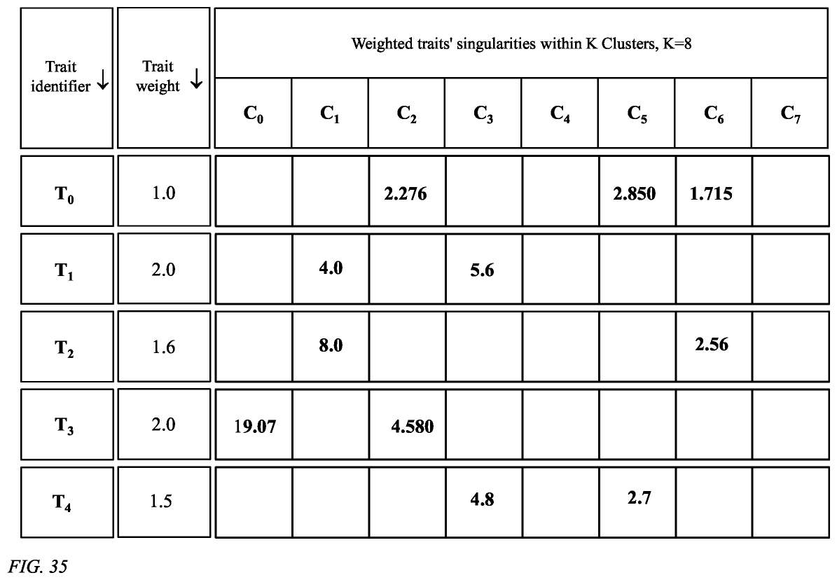

FIG. 35 illustrates trait singularities within different clusters for traits T₀, T₂, T₂, T₃, and T₄, where the traits are given weights of 1.0, 2.0, 1.6, 2.0, and 1.5 respectively.

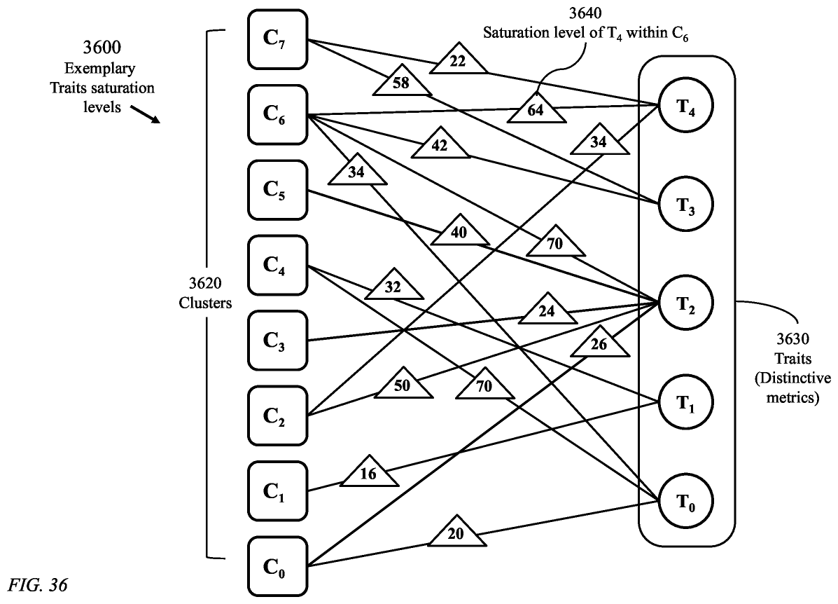

FIG. 36 illustrates exemplary traits' saturation levels (reference 3600) within clusters. Each trait of the set 3630 of traits T₀, T₂, T₂, T₃, and T₄ is present in at least one cluster of the set 3620 clusters C₀ to C₇.

The saturation levels (reference 3640) of each trait within respective clusters are indicated. For example, trait T₀ is associated with 20 users in cluster C₀, 70 users of cluster C₄, and 34 users in cluster C₆.

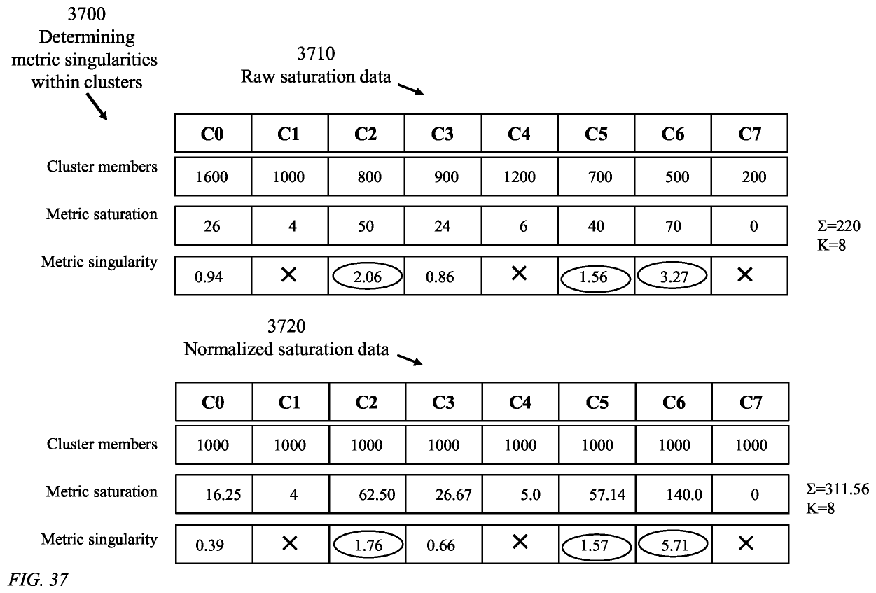

FIG. 37 illustrates an example 3700 of trait singularities within different clusters based on both raw saturation levels and normalized saturation levels. As illustrated in FIG. 36, trait T₂ has saturation levels (reference 3640) within clusters C₀, C₂, C₃, C₅, and C₆ of 26. 50, 24, 40, and 70. The saturation levels of T₂ within clusters C₁, C₄, and C₇ are insignificant. Table 3710 illustrates raw saturation data where a cluster's number of users is not taken into consideration while Table 3720 illustrates saturation data prorated (normalized) to a nominal number of users per cluster of 1000.

Thus, the invention provides a method of machine-aided marketing where a marketing engine 180 is employed to track a plurality of users to acquire individual user characteristics of a predefined set of characteristics and individual user metrics of a predefined set of metrics of behaviour. The plurality of users is segmented (FIG. 4, FIG. 12) into a plurality of clusters, each cluster comprising users selected according to mutual affinity based on the individual user characteristics. A metric-saturation level of each metric of the plurality of metrics within a cluster of the plurality of clusters is then determined (FIG. 25, FIG. 26, FIG. 36) as a function of a number of users within the cluster to which the specific metric pertains. This applies to each cluster of the plurality of clusters. For each metric, a respective set of target clusters within the plurality of clusters is determined (FIG. 34, FIG. 35) according to metric-saturation levels.

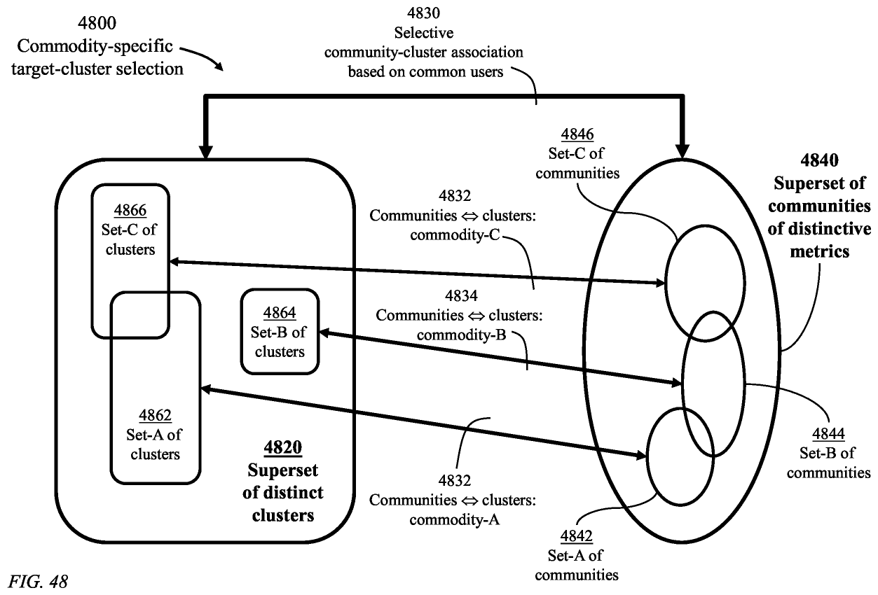

Upon receiving an identifier of a specific commodity from an operator of the marketing engine, a set of relevant metrics for the specific commodity; is selected from the predefined set of metrics (1120, FIG. 11). For each relevant metric, a set of target clusters is determined (FIG. 34, FIG. 48). A target cluster may correspond to more than one relevant metric. Thus, the marketing engine communicates with users belonging to a union of sets of target clusters corresponding to the set of relevant metrics.

Alternatively, upon selecting the set of relevant metrics, a set of communities having a one-to-one correspondence to the set of relevant metrics, where each community comprises users to which a relevant metric pertains, is formed (FIG. 5, FIG. 6). A union of the set of communities and the sets of target clusters corresponding to the set of relevant metrics is determined (FIG. 48). The marketing engine then communicates with users belonging to the union.

In one implementation, the following processes determine the set of relevant metrics for a specific commodity:
(iv) acquiring metrics, belonging to the predefined set of metrics, of individual past consumers of the specific commodity;
(v) determining a metric-relevance score (1140, FIG. 11) for each metric of the predefined set of metrics as a number of past consumers 1112 to which the metric pertains; and
(vi) including a metric in the set of relevant metrics subject to a determination that a corresponding metric-relevance score exceeds a prescribed threshold (for example, metrics M₃ and M₁, FIG. 11, are selected).
(vii) In another implementation, the set of relevant metrics and corresponding levels of relevance, for a specific commodity may be acquired from an operator of the marketing engine. Such information would be based on independent marketing studies.

A metric-specific set of target clusters for a specific metric may be determined according to the following processes (FIG. 29):
(c) initializing (process 2925) the metric-specific set of target clusters for the specific metric as an empty set; and
(d) for each cluster of the plurality of clusters:
   (b.1) determining a ratio (process 2940) of a respective metric-saturation level to mean metric-saturation level of remaining clusters; and
   (b.2) adding (process 2960) the cluster to the metric-specific set of target clusters subject to a determination that the ratio exceeds a predefined singularity threshold.

More specifically, a metric-specific set of target clusters for a specific metric may be determined according to the following processes:
(C) initializing (process 2925) the respective set of target clusters as an empty set;
(D) for each metric Mⱼ, 0≤j<μ, μ being a number of metrics of the predefined set of metrics (3010, FIG. 30):
   (B.1) determining (process 3060) a summation Σⱼ of S_{j,0} to S_{j,(K-1)}, K being a number of clusters of the plurality of clusters and S_{j,k} being a saturation score of metric j within cluster k;
   (B.2) determining (process 3080) a singularity η_{j,k} of metric-saturation of metric Mⱼ within a cluster k, 0≤k<K, as:

η_{j,k}=(K−1)×S_{j,k}/(Σⱼ−S_{j,k});
and
(B.3) subject to a determination that n_{j,k}>H, H being a predefined singularity threshold adding cluster k to the respective set of target clusters.

Alternatively, a metric-specific set of target clusters for a specific metric may be based on relative saturation according to the following processes (FIG. 31):
(1) initializing the respective set of target clusters as an empty set; and
(2) for each metric Mⱼ, 0≤j<μ, μ being a number of metrics of the set of candidate metrics:
   (2.1) determining (process 3140) a relative saturation α_{j,k} of Mⱼ, as α_{j,k}=S_{j,k}/Qₖ, Qₖ being a total number of users of cluster k, 0≤k<K, K being a number of clusters of the plurality of clusters and Sj,k being a saturation score of metric j within cluster k;
   (2.2) determining (process 3160) a summation Γⱼ of α_{j,0} to α_{j,(K-1)};
   determining a singularity λ_{j,k} of metric-singularity of metric Mⱼ within a cluster k, 0≤k<K, as:

λ_{j,k}=(K−1)×α_{j,k}/(Γⱼ−α_{j,k})
and
(2.3) subject to a determination that λ_{j,k}>H, H being a predefined singularity threshold adding cluster k to the set of bearing clusters.

An apparatus implementing the method comprises a hardware processor and a plurality of memory devices. Stored processor-executable instructions are organized into software modules including:
(i) a network interface (1610, FIG. 16) for tracking users;
(ii) a module (1640) for acquisition of users' characterization data from a first plurality of tracked users;
(iii) a module (460, FIG. 4, 1650) for segmenting the first plurality (1810, FIG. 18) of tracked users into a plurality of clusters (FIG. 12) according to users' characterization data;
(iv) a module (1660) for acquisition of metrics of a predefined set of metrics representing behaviour of a second plurality (1820, FIG. 18) of tracked users;
(v) a module (1720, FIG. 17) for determining a metric-saturation level of each metric in each cluster of the plurality of clusters as a function of a proportion of users of each cluster to which each metric pertains (FIGS. 25-28, 32-36); and
(vi) a module (1520, FIG. 15) for determining for each metric a respective set of target clusters (1560) within the plurality of clusters according to metric-saturation levels.

Modules (ii) to (vi) perform pre-processing functions aiming at providing information relevant to metric-specific target clusters. The information serves as a base for facilitating marketing functions including determining target clusters for a variety of commodities.

FIG. 38 illustrates a second method 3800 of determining distinctive metrics and corresponding clusters of users (a first method is illustrated in FIG. 29). Process 3810 selects a metric of the set of metrics. Process 3820 determines metric saturation within each of K clusters, K>1, as described with reference to FIG. 25 and FIG. 26.

Process 3830 sorts the K clusters in descending order according to metric saturation values. Process 3840 determines cumulative saturation values Q(χ), 0≤χ<K, of the K sorted clusters. The sum Σ of the K metric saturation values (process 3850) is then Q(K−1). A reference cumulative saturation value Ś is determined as Q(k*) where k* is predefined determinant number of clusters.

A preferred value of k* is └K/2┘,

Process 3860 determines the reference cumulative saturation value Ś as Ś=Q(k*) and a concave-saturation threshold S* as a predefined proportion θ of Σ, 0<θ<1.0; e.g., S*=0.7×Σ.

Process 3870 determines whether Ś is greater than S*. If so, process 3880 selects the metric as a trait and another metric, if any, is selected in process 3810. Otherwise, if Ś≤S*, the metric is discarded (process 3882) and a new metric, if any, is selected in process 3810. Process 3890 selects clusters each having a saturation level exceeding the mean saturation level Σ/K.

FIG. 39 illustrates a variation 3900 of the second method 3800 of determining distinctive metrics and corresponding clusters of users. Processes 3810 and 3820 are common in the methods of FIG. 24 and FIG. 39.

Process 2530 sorts the K clusters in ascending order according to metric saturation values. Process 2540 determines cumulative saturation values P(χ), 0≤χ<K, of the K sorted clusters. The sum Σ of the K metric saturation values (process 2550) is then P(K−1).

A reference cumulative saturation value [symbol] is determined as P(χ*) where χ* is predefined determinant number of clusters. A preferred value of χ* is └(K+1)/2┘.

Process 2560 determines the reference cumulative saturation value [symbol] as [symbol] =P(χ*) and a convex-saturation threshold S as a predefined proportion ϕ of Σ, 0<ϕ<1.0; e.g., Š=0.3×Σ.

Process 3870 determines whether [symbol] is less than or equal to Š. If so, process 2580 selects the metric as a trait and another metric, if any, is selected in process 3810. Otherwise, if [symbol] >Š, the metric is discarded and a new metric, if any, is selected in process 3810. Process 2590 selects clusters each having a saturation level exceeding the mean saturation level Σ/K.

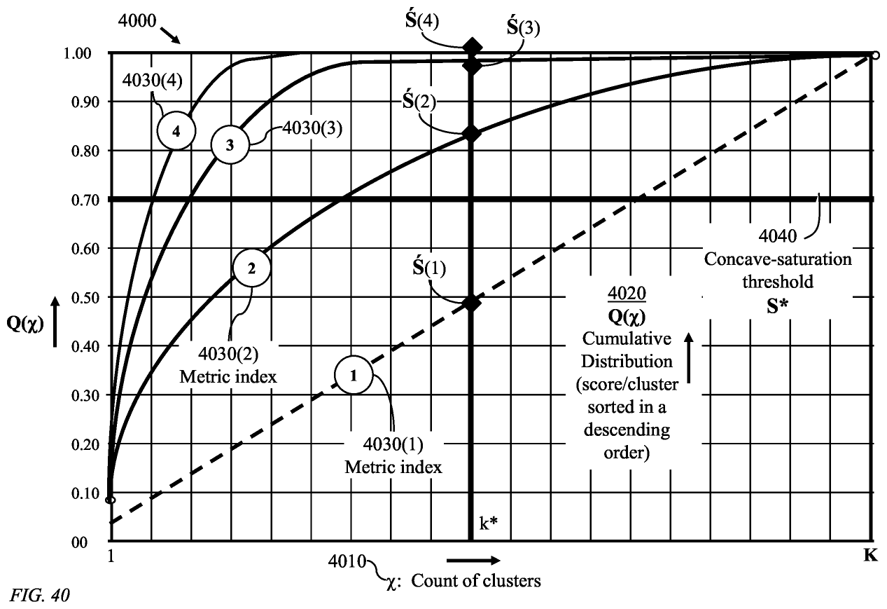

FIG. 40 illustrates an example 4000 of determining clusters of significant metric saturation based on the method of FIG. 38. Process 3830 sorts the K clusters in a descending order according to saturation level. The sorted clusters are indexed as κ. 0≤κ<K. Four metrics are considered, identified using indices 4030 of 1, 2, 3, and 4. Process 3850 determines a cumulative distribution 4020 of cluster saturation sorted in descending order for each of the four metrics.

The concave-saturation threshold S* (reference 4040) is selected as 0.7×Σ. The determinant number of clusters is determined as k*=└K/2┘.

The reference cumulative distribution value Ś(1) of metric 4030(1) is below S*. Therefore, metric 4030(1) is considered indistinctive. Each of reference cumulative distribution values Ś(2), Ś(3), and Ś(4) is larger than S*. Hence metrics 4030(2), 4030(3), and 4030(4) are distinctive and may be used as traits.

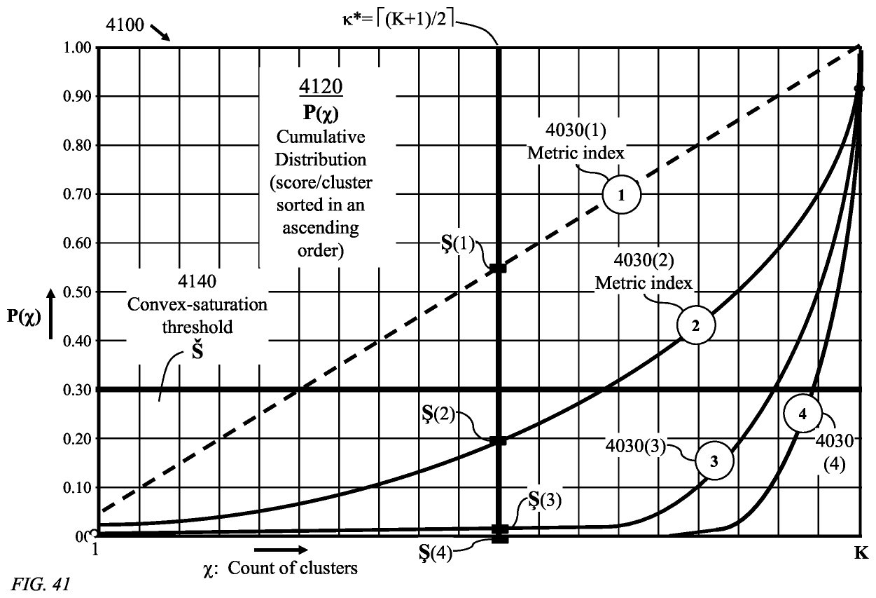

FIG. 41 illustrates an example 4100 of determining clusters of significant metric saturation based on the method of FIG. 39 where the K clusters are sorted in ascending order according to metric saturation values. The cumulative distributions P(κ), 0≤κ<K, (reference 4120) of cluster saturation for the four metrics 4030(1) to 4030(4) are determined.

The convex-saturation threshold Š (reference 4140) is selected as 0.3×Σ. The determinant number of clusters is determined as κ*=4(K±1)/2┘.

The reference cumulative distribution levels for a metric is determined as P(κ*). The reference cumulative distribution value [symbol] (1) of metric 4030(1) is larger than saturation threshold Š. Therefore, metric 4030(1) is considered indistinctive. Each of reference cumulative distribution values [symbol] (2), [symbol] (3), and Š(4) is less than Š. Hence metrics 4030(2), 4030(3), and 4030(4) are distinctive and may be used as traits.

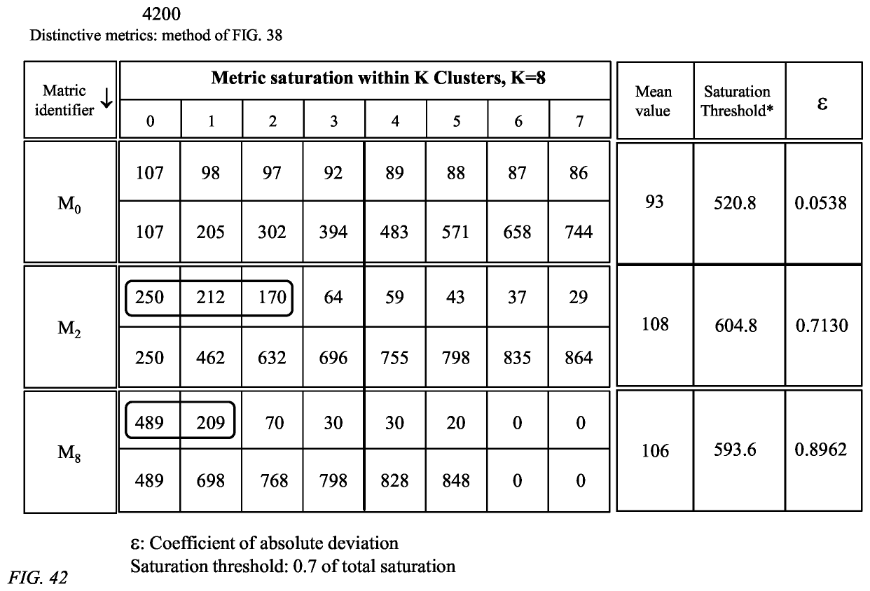

FIG. 42 illustrates an example 4200 of clusters of significant metric saturation employing the method of FIG. 38 for metrics M₀, M₂, and M₈ based on the metric saturation levels of FIG. 32 and the metric singularities of FIG. 33. For each metric 4210, respective metric saturation levels 4220 within clusters C₀ to C₇ are listed in a descending order and corresponding cumulative saturation values 4230 are indicated. The determinant number of clusters is k*=└K/2┘=4.

The mean value (reference 4250), concave-saturation threshold S* (reference) 4260, and coefficient of absolute deviation ε (reference 4270) are indicated.

For metric M₀, the concave-saturation threshold S* is 520.8 while the reference cumulative saturation Q(3)=394 which is less than S*. Hence metric M₀ is indistinctive.

For metric M₂, the concave-saturation threshold S* is 604.8 while the reference cumulative saturation Q(3)=696 which is larger than S*. Hence metric M₂ is distinctive. The mean value of cluster saturation is 108. Each of the metric saturation values 250, 212, and 170 is greater than the mean saturation value. Hence, the corresponding three clusters are selected.

For metric M₈, the concave-saturation threshold S* is 593.6 while the reference cumulative saturation Q(3)=798 which is larger than S*. Hence metric M₈ is distinctive. The mean value of cluster saturation is 106. Each of the metric saturation values 489 and 209 is greater than the mean saturation value. Hence, the corresponding two cluster are selected.

It is noticed that the coefficient of absolute deviation, ε, for each of the distinctive metrics M₂ and M₈ is significantly higher than that of the indistinctive metric M₀.

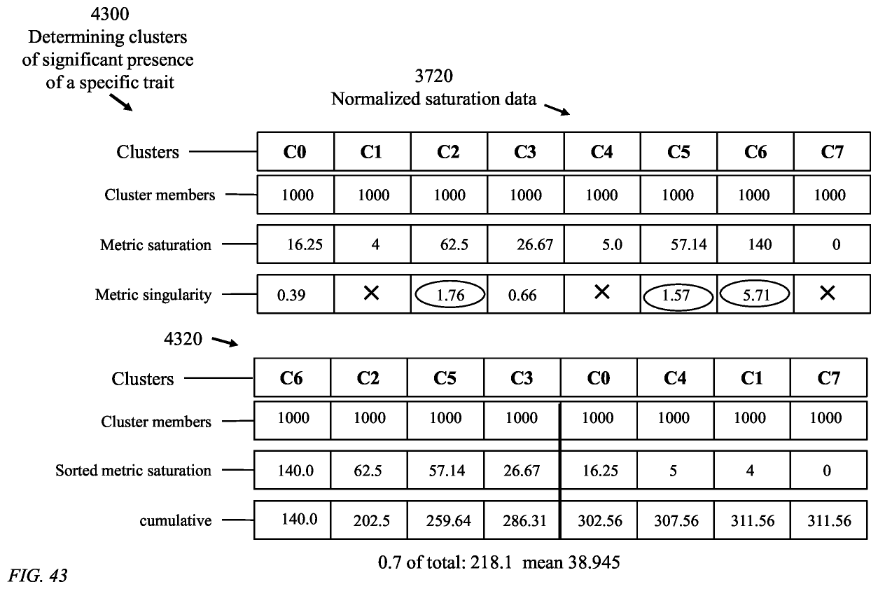

FIG. 43 illustrates a comparison 4300 of results of the method of FIG. 29 and the method of FIG. 38 applied to determining clusters of significant presence of a specific metric.

Metric singularity values within eight clusters determined according to the method of FIG. 29 are indicated in FIG. 37. Table 3720 of FIG. 37 (reproduced in FIG. 43) illustrates metric saturation levels normalized to a nominal number of users per cluster of 1000. As illustrated in FIG. 37, the metric under consideration has normalized saturation levels of 16.25, 4.0, 62.5, 26.67, 5.0, 57.14, 140.0, and 0.0 within clusters C₀, C₁, C₂, C₃, C₄, C₅, C₆ and C₇, respectively. A predefined singularity threshold H is set to equal 1.4. The singularity of the metric within each of clusters C₀, C₁, C₃, C₄, and C₇ is less than the singularity threshold H. The singularity levels of the metric within clusters C₆, C₂, and C₅ are determined as 5.71, 1076, and 1.57. Hence, clusters C₆, C₂, and C₅ are selected for further processing for marketing purposes.

Table 4320 illustrates the metric saturation levels of Table 3720 sorted in a descending order and the cumulative saturation values are determined as illustrated in FIG. 40. The sum Σ of metric saturation values is 311.56, the mean saturation value is 38.945, and the concave-saturation threshold S*=0.7×311.56=218.1. The determinant number of clusters k* is └K/2┘=4.

The reference cumulative saturation Ś equals Q(k*)=286.31 which is larger than S*. Hence, the metric is distinctive. The saturation levels of the metric within clusters C6, C2, and C5 are 140, 62.5, and 57.14, each of which is larger than the mean saturation value. Hence, clusters C6, C2, and C5 are selected for further processing.

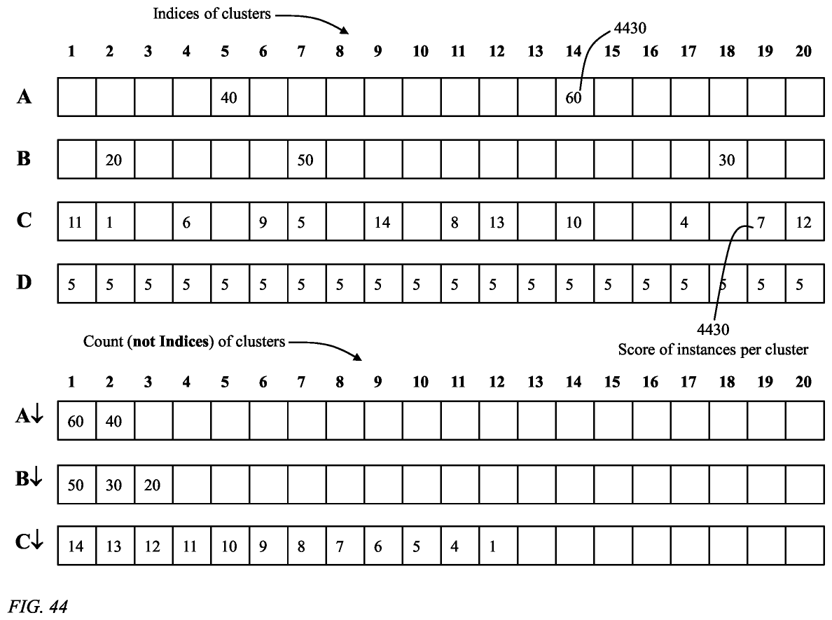

FIG. 44 illustrates a process of sorting cluster in a descending order according to metric-saturation values and a process of determining cumulative saturation values for sorted clusters according to the method of FIG. 38. Four candidate metrics labeled A, B, C, and D are considered.

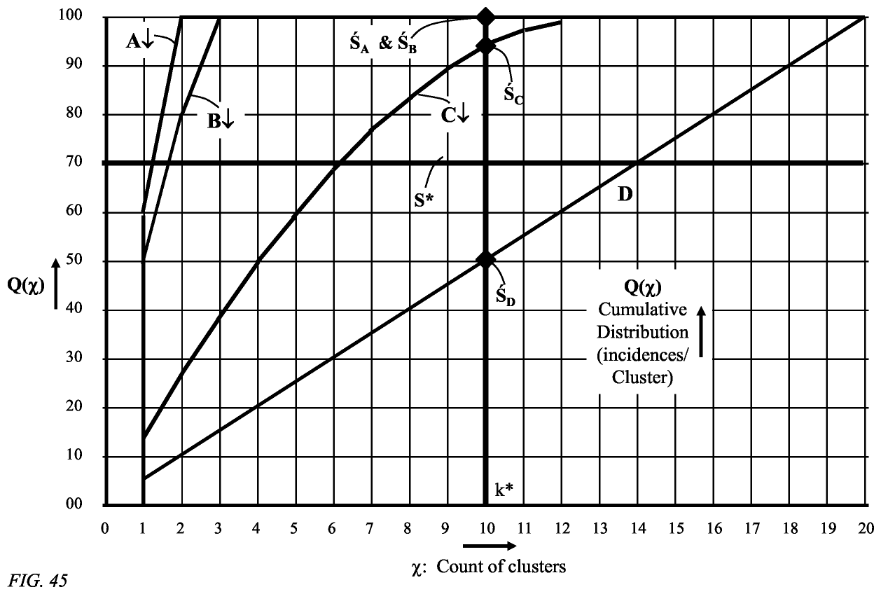

FIG. 45 further illustrates the processes of FIG. 44. With K=20, k*=10, and S* set to equal 0.7 of the sum of K metric saturation values, each of the reference cumulative saturation values Š_{A}, Š_{B}, and Š_{C} is larger than S*. Hence, metrics A, B, and C are considered distinctive, Š_{D} is less than S*, hence metric D is considered indistinctive.

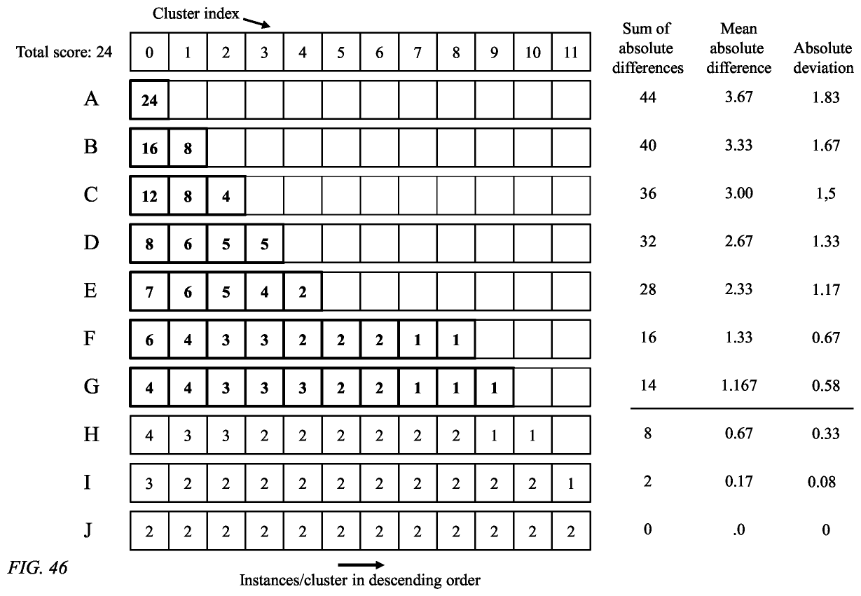

FIG. 46 illustrates coefficients of absolute deviation of saturation levels within different clusters.

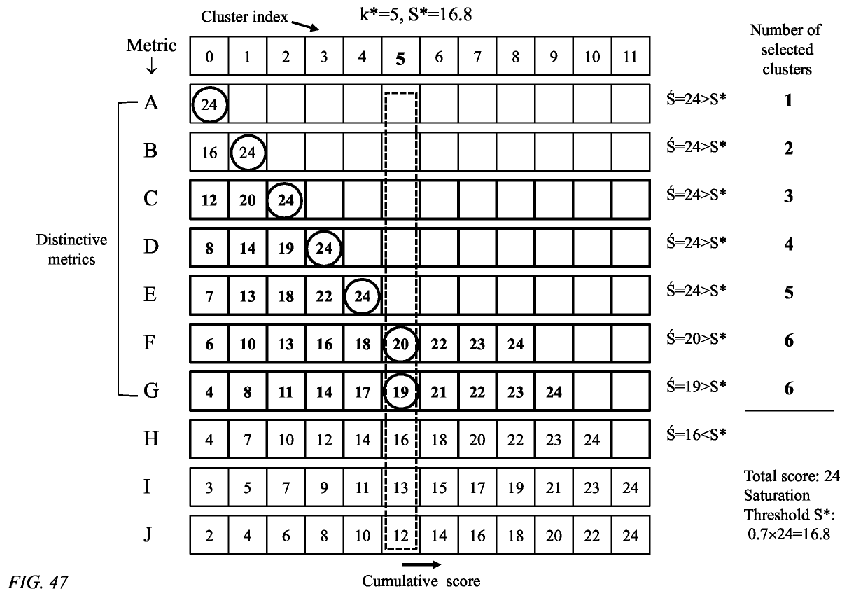

FIG. 47 illustrates clusters of significant metric saturation. Applying the method of FIG. 38, candidate metrics A to G are determined to be distinctive metrics—hence used as traits. Candidate metrics H, I, and J are considered indistinctive.

FIG. 48 illustrates a process 4800 of selecting commodity-specific target clusters. A set of distinctive metrics is determined according to the first method of FIG. 29 or the second method of FIG. 38. For each distinctive metric, a relevant set of clusters of the superset 480 of clusters is determined as illustrated in FIGS. 24, 25, and 27. The union of sets of clusters relevant to individual distinctive metrics forms superset 4820 of distinct clusters. For each distinctive metric, a community of users of the second population of users is determined. Thus, a superset 4840 of communities of all distinctive metrics is created. Associating clusters with metrics, hence with communities, (reference 4830) is based on common users of the first population of users and the second population of users which constitute the universe of users (FIG. 18).

Each commodity of a set of commodities under consideration is associated with a set of relevant metrics. According to an embodiment of the present invention, the set of relevant metrics of a commodity is determined based on individual metrics of seed users as illustrated in FIG. 11. Other methods may be used to determine relevant metrics for a commodity. The set of relevant metrics is pruned, to produce a pruned set of relevant metrics, where any metric that does not belong to the set of distinctive metrics is eliminated. Upon determining a pruned set of relevant metrics of a specific commodity, a set of clusters for each relevant metric is determined and the union of the sets of clusters corresponding to the relevant metrics of the pruned set of relevant metrics constitutes target clusters of the specific community.

As illustrated, a set of communities and a set of clusters are determined for each of three commodities under consideration. Set-A of clusters (reference 4862) is associated (reference 4832) with set-A of communities (reference 4842) which corresponds to a first commodity. Set-B of clusters (reference 4864) is associated (reference 4834) with set-B of communities (reference 4844) which corresponds to a second commodity. Set-C of clusters (reference 4866) is associated (reference 4836) with set-C of communities (reference 4846) which corresponds to a third commodity. The sets of metrics of different commodities may intersect. Thus, sets of communities corresponding to difference commodities may intersect and sets of clusters corresponding to different communities may intersect.

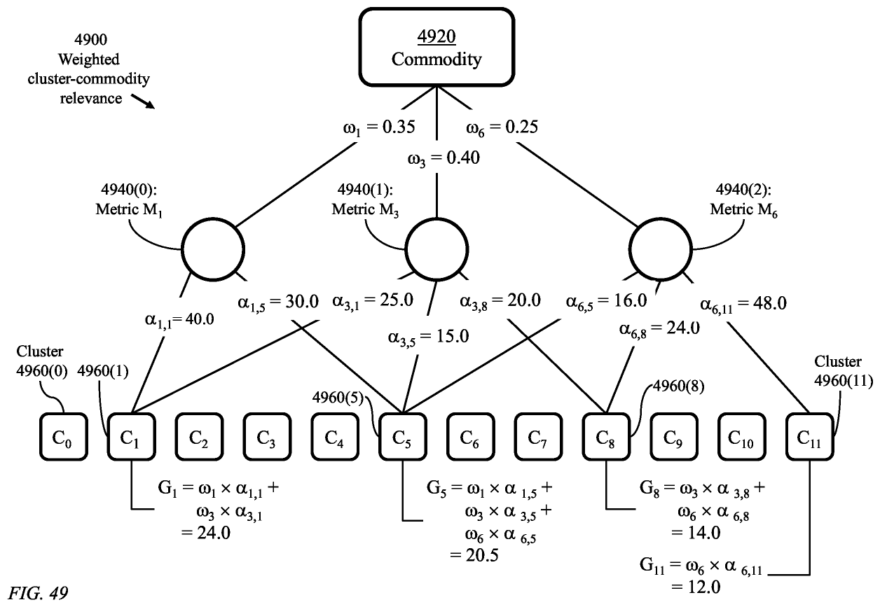

FIG. 49 illustrates a method 4900 of determining cluster-relevance levels for a commodity 4920. The method comprises processes of:
(i) identifying significant metrics 4940 of a predefined set of metrics for the commodity;
(ii) determining metric-relevance coefficients for each of the significant metrics;
(iii) determining a metric-saturation level of each significant metric within each cluster 4960 of the superset 4820 of distinct clusters; and
(iv) determining commodity-specific cluster merits for individual clusters of the superset 4820 of clusters according to metric-saturation levels within individual clusters and metric-relevance coefficients.

With respect to (i), FIG. 11 illustrates a process of identifying individual metrics, of a predefined set 1120 of metrics relevant to a specific commodity, based on metrics of individual seed users of an acquired set of seed users. Other means of determining commodity-specific relevant metrics may be considered.

With respect to (ii), commodity 4920 of FIG. 49 is equated to the commodity considered in FIG. 11. As illustrated in FIG. 11, the metric-relevance scores for significant metrics M₁, M₃, and M₆ are 7, 8, and 5, of a total of 20. Normalized metric-relevance coefficients of 0.35, 0.40, and 0.25 (of a total of 1.0) may be used to weigh relevance of the individual significant metric to the specific commodity. The metric-relevance coefficients of metrics of M₁, M₃, and M₆ are denoted ω₁, ω₃, and ω₆ respectively.

With respect to (iii), FIG. 24 and FIG. 25 visualize processes of determining metric saturation scores within clusters. FIG. 28 illustrates a method of determining metric saturation within clusters. Twelve clusters 4960(0) to 4960(11), labeled {C₀, C₁, . . . C₁₁}, are considered in the example of FIG. 49. Metric M₁ has saturation levels α_{1,1} of 40.0 within cluster C₁, and α_{1,5} of 30.0 within cluster C₅. Metric M₃ has saturation scores α_{3,1} of 25.0 within cluster C₁, α_{3,5} of 15.0 within cluster C₅, and α_{3,8} of 20.0 within cluster C₈. Metric M₆ has saturation scores α_{6,5} of 16.0 within cluster χ₅, α_{6,8} of 24.0 within cluster C₈, and α_{6,11} of 48.0 within cluster C₁₁. A metric-saturation level within a cluster is a metric score prorated to a nominal cluster size of 1000 (or any other prescribed nominal cluster size).

With respect to (iv), the cluster merit G₁ of cluster χ₁ is determined as:

G₁=ω₁×α_{1,1}+ω₂×α_{3,1}.

The cluster merit G₅ of cluster χ₅ is determined as:

G₅=ω₁×α_{1,5}+ω₃×α_{3,5}+ω₆×α_{6,5}.

The cluster merit G₈ of cluster χ₈ is determined as:

G₈=ω₃×α_{3,8}+ω₆×α_{6,8}.

The cluster merit G₁₁ of cluster xii is determined as:

G₁₁=ω₆×α_{6,11}.

With ω₁, ω₃, and ω₆ determined as 0.35, 0.40, and 0.25, respectively, as described above, the merits G₁, G₅, G₈, and G₁₁ of clusters C₁, C₅, C₈, and C₁₁ are determined as 24.0, 20.5, 14.0, and 12.0, respectively. The merit for each of the eight remaining clusters with respect to commodity 4920 is zero.

In a preprocessing stage, metric-saturation scores of a predefined set of metrics within a superset of clusters are determined and periodically updated. Table-IV indicates saturation scores of predefined metrics M₀ to M₆ within cluster C₀ to C₁₁. The cluster sizes vary between 594 users (cluster C₅) and 2107 users (cluster C₁₀). Table-V indicates normalized saturation levels where a prorated saturation level α_{j,k} of a metric Mⱼ within cluster Cₖ is determined from a corresponding saturation score S_{j,k} as α=_{j,k}=1000×S_{j,k}/Q(k), Q(k) being the size of cluster Cₖ.

TABLE IV
Score of metric-saturation within clusters

| Cluster | Cluster | Metrics | | | | | | |
|---|---|---|---|---|---|---|---|---|
| ↓ | size ↓ | M₀ | M₁ | M₂ | M₃ | M₄ | M₅ | M₆ |
| C₀ | 924 | 14 | 5 | 32 | 4 | 35 | 6 | 4 |
| C₁ | 1724 | 24 | 8 | 17 | 6 | 16 | 21 | 8 |
| C₂ | 1258 | 2 | 32 | 5 | 34 | 2 | 4 | 21 |
| C₃ | 1600 | 17 | 11 | 11 | 9 | 21 | 22 | 9 |
| C₄ | 1280 | 25 | 5 | 17 | 3 | 21 | 17 | 12 |
| C₅ | 594 | 26 | 9 | 12 | 6 | 17 | 22 | 8 |
| C₆ | 1420 | 2 | 40 | 4 | 25 | 2 | 4 | 23 |
| C₇ | 1028 | 20 | 5 | 12 | 24 | 10 | 18 | 11 |
| C₈ | 1612 | 3 | 29 | 2 | 20 | 0 | 4 | 42 |
| C₉ | 1209 | 2 | 2 | 35 | 12 | 40 | 0 | 9 |
| C₁₀ | 2107 | 19 | 6 | 12 | 7 | 10 | 40 | 6 |
| C₁₁ | 1952 | 14 | 46 | 4 | 22 | 4 | 2 | 8 |

| | | | | | | | |
|---|---|---|---|---|---|---|---|
| Overall Metric | 168 | 198 | 163 | 172 | 178 | 160 | 161 |
| saturation | | | | | | | |

TABLE V
Normalized metric saturation within clusters

| Cluster | Cluster | Metrics | | | | | | |
|---|---|---|---|---|---|---|---|---|
| ↓ | size ↓ | M₀ | M₁ | M₂ | M₃ | M₄ | M₅ | M₆ |
| C₀ | 924 | 15.15 | 5.41 | 34.63 | 4.33 | 37.88 | 6.49 | 4.33 |
| C₁ | 1724 | 13.92 | 4.64 | 9.86 | 3.48 | 9.28 | 12.18 | 4.64 |
| C₂ | 1258 | 1.59 | 25.44 | 3.97 | 27.03 | 1.59 | 3.18 | 16.69 |
| C₃ | 1600 | 10.63 | 6.88 | 6.88 | 5.63 | 13.13 | 13.75 | 5.63 |
| C₄ | 1280 | 19.53 | 3.91 | 13.28 | 2.34 | 16.41 | 13.28 | 9.38 |
| C₅ | 594 | 43.77 | 15.15 | 20.20 | 10.10 | 28.62 | 37.04 | 13.47 |
| C₆ | 1420 | 1.41 | 28.17 | 2.82 | 17.61 | 1.41 | 2.82 | 16.20 |
| C₇ | 1028 | 19.46 | 4.86 | 11.67 | 23.35 | 9.73 | 17.51 | 10.70 |
| C₈ | 1612 | 1.86 | 17.99 | 1.24 | 12.41 | 0 | 2.48 | 26.05 |
| C₉ | 1209 | 1.65 | 1.65 | 28.95 | 9.93 | 33.09 | 0 | 7.44 |
| C₁₀ | 2107 | 9.02 | 2.85 | 5.70 | 3.32 | 4.75 | 18.98 | 2.85 |
| C₁₁ | 1952 | 7.17 | 23.57 | 2.05 | 11.27 | 2.05 | 1.02 | 4.10 |

Table-VT indicates commodity-specific metric-saturation scores within clusters C₀ to C₁₁ for two commodities. It is conjectured, or determined from analysis of past consumers, that metric set {M₁, M₃, M₆} is relevant to the first commodity, labeled commodity-A, while metric set {M₂, M₄} is relevant to the second commodity, labeled commodity-B. Metric set {M₁, M₃, M₆} has a saturation score of 91 within cluster C₈ and a saturation score of only 13 within cluster C₀. Metric set {M₂, M₄} has a saturation score of 75 within cluster C₉ and a saturation score of only 2 within cluster C₈.

Table-VII indicates commodity-specific normalized metric saturation within clusters C₀ to C₁₁ for the two commodities where the metric-saturation scores are prorated to a nominal cluster size of 1000. Metric set {M₁, M₃, M₆} has a prorated metric-saturation level of 69.12 within cluster C₂ and a prorated metric-saturation level of only 9.02 within cluster C₁₀. Metric set {M₂, M₄} has a prorated saturation level of 62.04 within cluster C₉ and a saturation score of only 1.24 within cluster C₈.

TABLE VI
Commodity-specific score of metric-saturation within clusters

| | | | | | | Commodity-B | | |
|---|---|---|---|---|---|---|---|---|
| | | Commodity-A | | | | Individual | | |
| Cluster | Cluster | Individual metrics | | | Metric | metrics | | Metric |
| ↓ | size ↓ | M₁ | M₃ | M₆ | set | M₂ | M₄ | set |
| C₀ | 924 | 5 | 4 | 4 | 13 | 32 | 35 | 67 |
| C₁ | 1724 | 8 | 6 | 8 | 22 | 17 | 16 | 33 |
| C₂ | 1258 | 32 | 34 | 21 | 87 | 5 | 2 | 7 |
| C₃ | 1600 | 11 | 9 | 9 | 29 | 11 | 21 | 32 |
| C₄ | 1280 | 5 | 3 | 12 | 20 | 17 | 21 | 38 |
| C₅ | 594 | 9 | 6 | 8 | 23 | 12 | 17 | 29 |
| C₆ | 1420 | 40 | 25 | 23 | 88 | 4 | 2 | 6 |
| C₇ | 1028 | 5 | 24 | 11 | 40 | 12 | 10 | 22 |
| C₈ | 1612 | 29 | 20 | 42 | 91 | 2 | 0 | 2 |
| C₉ | 1209 | 2 | 12 | 9 | 23 | 35 | 40 | 75 |
| C₁₀ | 2107 | 6 | 7 | 6 | 19 | 12 | 10 | 22 |
| C₁₁ | 1952 | 46 | 22 | 8 | 76 | 4 | 4 | 8 |

| | | | | | | | |
|---|---|---|---|---|---|---|---|
| Overall Metric | 198 | 172 | 161 | 531 | 163 | 178 | 341 |
| saturation score | | | | | | | |

TABLE VII
Commodity-specific normalized metric saturation within clusters

| | | | | | | Commodity-B | | |
|---|---|---|---|---|---|---|---|---|
| | | Commodity-A | | | | Individual | | |
| Cluster | Cluster | Individual metrics | | | Metric | metrics | | Metric |
| ↓ | size ↓ | M₁ | M₃ | M₆ | set | M₂ | M₄ | set |
| C₀ | 924 | 5.41 | 4.33 | 4.33 | 14.07 | 34.63 | 37.88 | 72.51 |
| C₁ | 1724 | 4.64 | 3.48 | 4.64 | 12.76 | 9.86 | 9.28 | 19.14 |
| C₂ | 1258 | 25.44 | 27.03 | 16.69 | 69.16 | 3.97 | 1.59 | 5.56 |
| C₃ | 1600 | 6.88 | 5.63 | 5.63 | 18.14 | 6.88 | 13.13 | 20.01 |
| C₄ | 1280 | 3.91 | 2.34 | 9.38 | 15.63 | 13.28 | 16.41 | 29.69 |
| C₅ | 594 | 15.15 | 10.10 | 13.47 | 38.72 | 20.20 | 28.62 | 48.82 |
| C₆ | 1420 | 28.17 | 17.61 | 16.20 | 61.98 | 2.82 | 1.41 | 4.23 |
| C₇ | 1028 | 4.86 | 23.35 | 10.70 | 38.91 | 11.67 | 9.73 | 21.40 |
| C₈ | 1612 | 17.99 | 12.41 | 26.05 | 56.45 | 1.24 | 0.0 | 1.24 |
| C₉ | 1209 | 1.65 | 9.93 | 7.44 | 19.02 | 28.95 | 33.09 | 62.04 |
| C₁₀ | 2107 | 2.85 | 3.32 | 2.85 | 9.02 | 5.70 | 4.75 | 10.45 |
| C₁₁ | 1952 | 23.57 | 11.27 | 4.10 | 38.94 | 2.05 | 2.05 | 4.10 |

Table-VIII indicates commodity-specific normalized metric saturation within clusters C₀ to C₁₁ for the two commodities where the metric-saturation scores are prorated to a nominal cluster size of 1000 and relevance weighted according to a commodity-specific levels of relevance of each relevant metric. The levels of relevance of metrics M₁, M₃, and M₆ are proportionate to the metric-relevance scores of 7, 8, and 5 of for the exemplary commodity considered in FIG. 11. The table indicates the relevance-weighted prorated (normalized) saturation score for each of the relevant metrics of commodity-A. The relevance-weighted prorated (normalized) saturation score of the metric set {M₁, M₃, M₆} defines a commodity-specific cluster merit for commodity-A. Cluster C₂ has the highest cluster merit of 71.66 while cluster C₁₀ has the lowest cluster merit.

TABLE VIII
Commodity-specific normalized-weighed
metric-saturation within clusters

| | | Commodity-A | | | |
|---|---|---|---|---|---|
| | | Individual metrics & corresponding weights | | | |
| Cluster | Cluster | M₁ | M₃ | M₆ | Metric |
| ↓ | size ↓ | (1.05) | (1.20) | (0.75) | set |
| C₀ | 924 | 5.68 | 5.20 | 3.25 | 14.13 |
| C₁ | 1724 | 4.87 | 4.18 | 3.48 | 12.53 |
| C₂ | 1258 | 26.71 | 32.44 | 12.51 | 71.66 |
| C₃ | 1600 | 7.22 | 6.76 | 4.22 | 18.20 |
| C₄ | 1280 | 4.11 | 2.81 | 7.04 | 13.96 |
| C₅ | 594 | 15.91 | 12.12 | 10.10 | 38.13 |
| C₆ | 1420 | 29.58 | 21.13 | 12.15 | 62.86 |
| C₇ | 1028 | 5.10 | 28.02 | 8.03 | 41.15 |
| C₈ | 1612 | 18.89 | 14.89 | 19.54 | 53.32 |
| C₉ | 1209 | 1.73 | 11.92 | 5.58 | 19.23 |
| C₁₀ | 2107 | 2.99 | 3.98 | 2.14 | 9.11 |
| C₁₁ | 1952 | 24.75 | 13.52 | 3.08 | 41.35 |

Table-IX indicates a set of commodities which may include a large number of commodities of interest. In the preprocessing stage, it may be advantageous to identify metrics relevant to each commodity and corresponding metric-relevance levels using the method of FIG. 11, for example. The relevant metrics are selected from a predefined set of metrics of personal behaviour. Table-IX indicates relevant metrics, selected from predefined metrics M₀, M₁, M₂, M₃, M₄, M₅, and M₆, for each of 97 commodities labelled X⁽¹⁾ to X⁽⁹⁹⁾. Blank entries in Table-IX indicate irrelevance of a metric to a respective commodity.

Metrics M₁, M₃, and M₆ are determined to be relevant to commodity X⁽¹⁾ with respective metric-relevance levels of ⁽¹⁾Ω₁, ⁽¹⁾Ω₃, and ⁽¹⁾Ω₆. Metrics M₁, M₂, M₄, and M₆ are determined to be relevant to commodity X⁽⁹⁶⁾ with respective metric-relevance levels of ⁽⁹⁶⁾Ω₁, ⁽⁹⁶⁾Ω₂, ⁽⁹⁶⁾Ω₄, and ⁽⁹⁶⁾Ω₆.

TABLE IX
Commodity-specific metric-relevance levels

Commodity

| to promote | Metric | | | | | | |
|---|---|---|---|---|---|---|---|
| ↓ | M₀ | M₁ | M₂ | M₃ | M₄ | M₅ | M₆ |
| X⁽¹⁾ | | ⁽¹⁾Ω₁ | | ⁽¹⁾ Ω₃ | | | ⁽¹⁾ Ω₆ |
| X⁽²⁾ | ⁽²⁾ Ω₀ | | ⁽²⁾ Ω₂ | | | ⁽²⁾ Ω₅ | |
| . | | | | | | | |
| . | | | | | | | |
| . | | | | | | | |
| X⁽⁹⁶⁾ | | ⁽⁹⁶⁾ Ω₁ | ⁽⁹⁶⁾ Ω₂ | | ⁽⁹⁶⁾ Ω₄ | | ⁽⁹⁶⁾ Ω₆ |
| X⁽⁹⁷⁾ | | | | | | | |

As illustrated in FIG. 11, the predefined set 1120 of metrics comprises seven metrics denoted M₀, M₁, M₂, M₃, M₄, M₅, and M₆ of which metrics M₁, M₃, and M₆ are considered significant metrics for a specific commodity. Metric-relevance scores 1140 are determined for the set of seed users (past consumers). A score 1142 of relevance of a specific metric to the specific commodity is determined based on relevant metrics for each seed user 1112. As described above with reference to FIG. 49, normalized metric-relevance coefficients of 0.35, 0.40, and 0.25 (of a total of 1.0) may be used to weigh relevance to the specific commodity of the individual significant metrics M₁, M₃, and M₆.

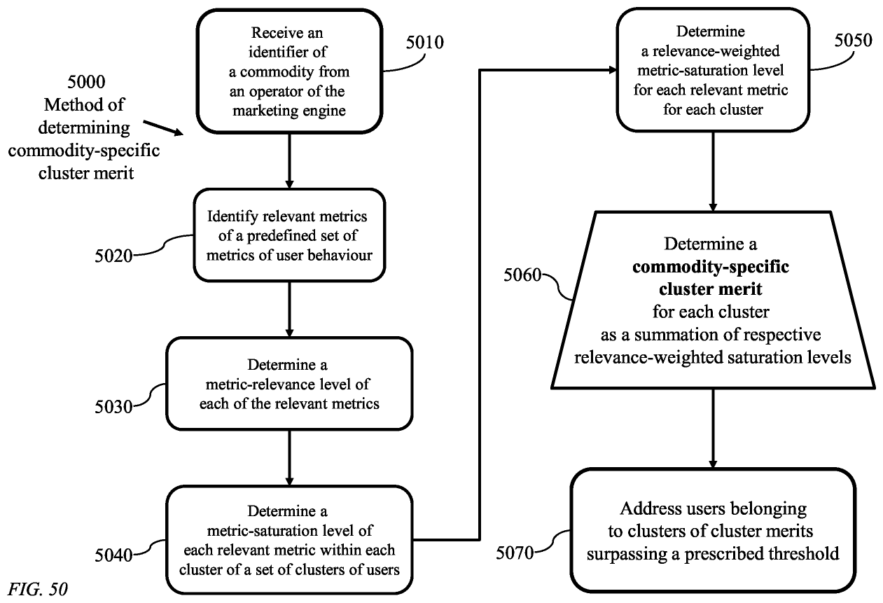

FIG. 50 illustrates a method 5000 of machine-aided marketing. Upon receiving (process 5010) an identifier of a specific commodity 4920 from an operator of a marketing engine 1600/1700 comprising at least one processor 1620/1710, the marketing engine performs processes 5020, 5030, 5040, 5050, 560, and 5070.

Process 5020 identifies a set of metrics relevant to the specific commodity. Process 5030 determines a metric-relevance level of each relevant metric. The relevant metrics identifiers and corresponding metric-relevance levels may be extracted from Table VIII or computed using the method of FIG. 11, for example. The information may also be received from the operator of the marketing engine.

Process 5040 determines a metric-saturation level of each relevant metric within each cluster of a set of clusters of users of a plurality of users of social-media. FIG. 25, FIG. 26, and FIG. 27 illustrate processes of determining metric-saturation scores within clusters. A metric-saturation level corresponding to a metric-saturation score for a specific cluster may be determined as the ratio of the metric-saturation score to the size of the cluster or as the metric-saturation score prorated to a nominal cluster size as illustrated in FIG. 37 for a nominal cluster size of 1000.

Process 5050 determines a relevance-weighted metric-saturation level for each relevant metric for each cluster. Table-X indicates saturation levels of relevant metrics of commodity X⁽¹⁾ within a superset of clusters C₀ to C₁₁. A blank entry in the table indicates an insignificant saturation level. The relevance levels of metrics M₁, M₃, and M₆ are ⁽¹⁾Ω₁, ⁽¹⁾Ω₃, ⁽¹⁾Ω₆. The saturation levels of metric M₁, within clusters C₁ and C₅ are α_{1,1} and α_{1,5}, respectively. The relevance-weighted saturation levels are ⁽¹⁾Ω₁×α_{1,1} and ⁽¹⁾Ω₁×α_{1,5}, respectively. The saturation levels of metric M₆, within clusters C₅, C₈ and C₁₁ are α_{6,5}, α_{6,8} and α_{6,11}, respectively. The relevance-weighted saturation levels are ⁽¹⁾Ω₆×α_{6,5}, ⁽¹⁾Ω₆×α_{6,8}, and ⁽¹⁾Ω₆×α_{6,11}, respectively. Likewise, Table-XI indicates saturation levels of relevant metrics of commodity X⁽⁹⁶⁾ within a superset of clusters C₀ to C₁₁.

Process 5060 determines a commodity-specific cluster merit for each cluster of the superset of clusters. A commodity-specific cluster merit for a specific commodity and a specific cluster is the sum of relevance-weighted saturation levels within the specific cluster of all metrics determined to be relevant to the specific commodity (FIG. 11). Thus, the cluster merit of cluster C₅ with respect to commodity X⁽¹⁾ is determined as:

⁽¹⁾Ω₁×α_{1,5}+⁽¹⁾Ω₃×a_{3,5}+⁽¹⁾Ω₆×α_{6,5.}

The cluster merit of cluster C₈ with respect to commodity X⁽⁹⁶⁾ is determined as:

⁽⁹⁶⁾Ω₂×α_{2,8}+⁽⁹⁶⁾Ω₄×α_{4,8}+⁽⁹⁶⁾Ω₆×α_{6,8}.

Process 5070 communicates information relevant to a commodity under consideration to users belonging to clusters of cluster merits surpassing a prescribed threshold.

TABLE X
Metric-relevance levels and merit-saturation levels for commodity X⁽¹⁾

| Relevant | | | | | | | | | | | | |
|---|---|---|---|---|---|---|---|---|---|---|---|---|
| metric & | | | | | | | | | | | | |
| relevance | Cluster & metric saturation | | | | | | | | | | | |
| level ↓ | C₀ | C₁ | C₂ | C₃ | C₄ | C₅ | C₆ | C₇ | C₈ | C₉ | C₁₀ | C₁₁ |

| | | | | | |
|---|---|---|---|---|---|
| M₁ | ⁽¹⁾ Ω₁ | α_{1, 1} | α_{1, 5} | | |
| M₃ | ⁽¹⁾ Ω₃ | α_{3, 1} | α_{3, 5} | α_{3, 8} | |
| M₆ | ⁽¹⁾ Ω₆ | | α_{6, 5} | α_{6, 8} | α_{6, 11} |

TABLE XI
Metric-relevance levels and merit-saturation levels for commodity X⁽⁹⁶⁾

| Relevant | | | | | | | | | | | | |
|---|---|---|---|---|---|---|---|---|---|---|---|---|
| metric & | | | | | | | | | | | | |
| relevance | Cluster & metric saturation | | | | | | | | | | | |
| level ↓ | C₀ | C₁ | C₂ | C₃ | C₄ | C₅ | C₆ | C₇ | C₈ | C₉ | C₁₀ | C₁₁ |

| | | | | | |
|---|---|---|---|---|---|
| M₁ | ⁽⁹⁶⁾ Ω₁ | α_{1, 2} | α_{1, 4} | α_{1, 7} | |
| M₂ | ⁽⁹⁶⁾ Ω₂ | α_{2, 2} | α_{2, 4} | | α_{2, 8} |
| M₄ | ⁽⁹⁶⁾ Ω₄ | | α_{4, 4} | α_{4, 7} | α_{4, 8} |
| M₆ | ⁽⁹⁶⁾ Ω₆ | α_{6, 2} | | | α_{6, 8} |

Thus, the invention provides a method of machine-aided marketing based on employing a marketing engine to perform processes of acquiring an identifier of a commodity (5010, FIG. 50), from an operator of the marketing engine, for example, identifying a set of relevant metrics to the commodity from a predefined set of metrics of personal behaviour (FIG. 11, 4940, FIG. 49, 5020, FIG. 50), and determining a metric-relevance level of each of the relevant metrics (5030, FIG. 11, for example). The engine determines a metric-saturation level of each relevant metric within each cluster of a set of clusters of users of a plurality of users of social-media as well as a relevance-weighted metric-saturation level (5040, 5050) for each relevant metric for each cluster where each saturation level is multiplied by a respective metric-relevance level. Subsequently, a commodity-specific cluster merit for each cluster of the superset of clusters is determined (5060, FIG. 50) as a summation of respective relevance-weighted saturation levels;

A set of target clusters may then be determined based on commodity-specific cluster merits where each cluster having a cluster merit surpassing a prescribed threshold is included in the set of target clusters. The marketing engine communicates (5070) with users belonging to the set of target clusters.

The operator of the marketing engine may select the set of relevant metrics and provide corresponding metric-relevance levels. Alternatively, the set of relevant metrics and corresponding metric-relevance level of each relevant metric may be determined according to metric-relevance indications of individual consumers of a set of past consumers of the commodity as described above with reference to FIG. 11.

The plurality of users is segmented into the set of clusters according to mutual affinity of individual users (FIG. 4, module 1650 of FIG. 16). A metric-saturation of a specific metric within a specific cluster is a function of a number of users of the specific cluster to which the specific metric pertains. The relevance weighted metric saturation level of a specific metric within a specific cluster is a product of a metric-relevance level of the specific metric and a metric-saturation (process 5050, FIG. 50) of the specific metric within the specific cluster as illustrated in FIG. 49.

The method comprises further processes of forming a set of communities (FIG. 5, FIG. 6) having a one-to-one correspondence to the set of relevant metrics, each community comprising users to which a relevant metric pertains. The marketing engine determines a union of the set of communities and the set of target clusters. Thus, instead of communicating with users belonging to the set of target clusters, the marketing engine communicates with users belonging to the union of set of target clusters and the set of communities.

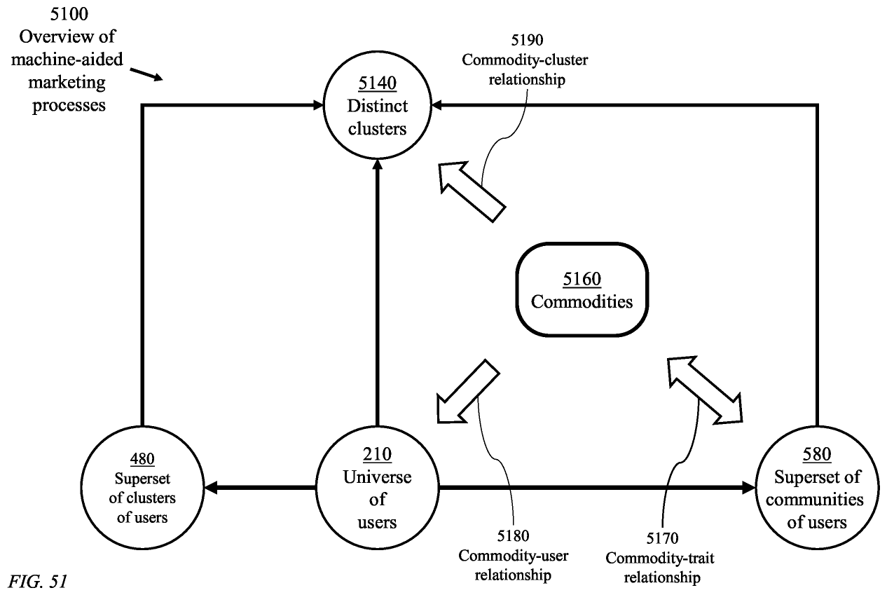

FIG. 51 illustrates an overview of machine-aided marketing processes 5100. As described above, a first population of users belonging to the universe 210 of users (FIG. 2) is segmented into a superset 480 of clusters according to individual user characteristics (properties). A second population of users belonging to the universe 210 of users is classified into a superset 580 of communities according to individual user traits. Distinct clusters 5140, each having a saturation level of a specific trait or a specific set of traits, are determined based on metric-saturation levels 840 (FIG. 8).

Commodities 5160 of interest are related to users of the universe 210 of users and distinct clusters 5140 of users according to process 1100 which determines relationships of user metrics (communities of users) to commodity consumption. Herein, the general term “users” refers to potential consumers of specific commodities such as products or services. Users of social media may be treated as potential consumers.

The marketing system is based on determining individual traits of users of the universe of users 210, or a segment thereof, and identifying distinct clusters 5140 of significant trait saturation. FIG. 29 and FIG. 38 illustrate details of determining distinctive metrics and corresponding sets of clusters.

Upon establishing correlation (process 4970) of individual commodities of interest 5160 to communities 580, each commodity may be related to respective users (process 5180) or respective distinct clusters (process 5190) to enable taking appropriate marketing actions.

Methods and systems of the embodiments of the present invention are typically applied to processing/clustering of a vast amount of data, for example social media or Internet data, and allow more expedient and accurate processing of the data, thus providing more accurate results compared with the prior art, and making the methods/systems of the present invention less computationally intense and more reliable and robust. For example, a marketing model constructed in accordance with embodiments of the invention would represent a more accurate perception of marketing trends.

The processes described above, as applied to a social graph of a vast population, require the use of multiple hardware processors. A variety of processors, such as microprocessors, digital signal processors, and gate arrays, may be employed. Generally, processor-readable media are needed and may include floppy disks, hard disks, optical disks, Flash ROMS, non-volatile ROM, and RAM.

Systems and apparatus of the embodiments of the invention may be implemented as any of a variety of suitable circuitry, such as one or more microprocessors, digital signal processors (DSPs), application-specific integrated circuits (ASICs), field programmable gate arrays (FPGAs), discrete logic, software, hardware, firmware or any combinations thereof. When modules of the systems of the embodiments of the invention are implemented partially or entirely in software, the modules contain a memory device for storing software instructions in a suitable, non-transitory computer-readable storage medium, and software instructions are executed in hardware using one or more processors to perform the techniques of this disclosure.

It should be noted that methods and systems of the embodiments of the invention and data sets described above are not, in any sense, abstract or intangible. Instead, the data is necessarily presented in a digital form and stored in a physical data-storage computer-readable medium, such as an electronic memory, mass-storage device, or other physical, tangible, data-storage device and medium. It should also be noted that the currently described data-processing and data-storage methods cannot be carried out manually by a human analyst, because of the complexity and vast numbers of intermediate results generated for processing and analysis of even quite modest amounts of data. Instead, the methods described herein are necessarily carried out by electronic computing systems having processors on electronically or magnetically stored data, with the results of the data processing and data analysis digitally stored in one or more tangible, physical, data-storage devices and media.

Although specific embodiments of the invention have been described in detail, it should be understood that the described embodiments are intended to be illustrative and not restrictive. Various changes and modifications of the embodiments shown in the drawings and described in the specification may be made within the scope of the following claims without departing from the scope of the invention in its broader aspect.

1. A method of machine-aided marketing comprising:
employing a hardware processor to execute processor-readable instructions for:
tracking a plurality of users to acquire:
individual user characteristics of a predefined set of characteristics; and
individual user metrics of a predefined set of metrics of behaviour;
segmenting said plurality of users into a plurality of clusters, each cluster comprising users selected according to mutual affinity based on the individual user characteristics; determining a metric-saturation level of each metric of the plurality of metrics within each cluster of die plurality of clusters as a function of a number of users within said each cluster to which the specific metric pertains; and
ascertaining for said each metric a respective set of target clusters within said plurality of clusters according to said metric-saturation level;
thereby, generating information for facilitating automated marketing functions.

2. The method of claim 1 further comprising:
obtaining an identifier of a specific commodity;
selecting a set of relevant metrics of the predefined set of metrics for die specific commodity;
determining a union of sets of target clusters corresponding to the set of relevant metrics; and
communicating with users belonging to said union of sets of target clusters.

3. The method of claim 1 further comprising:
selecting a set of relevant metrics of the predefined set of metrics for a specific commodity;
forming a set of communides having a one-to-one correspondence to the set of relevant metrics, each community comprising users to which a relevant metric pertains;
determining a union of:
sets of target clusters corresponding to the set of relevant metrics; and the set of communities; and
communicating with users belonging to said union.

4. The method of claim 2 wherein said selecting comprises:
acquiring metrics, belonging to the predefined set of metrics, of individual past consumers of the specific commodity;
determining a metric-relevance score for each metric of the predefined set of metrics as a number of past consumers to which said each metric pertains; and
including said each metric in said set of relevant metrics subject to a determination that said metric-relevance score exceeds a prescribed threshold.

5. The method of claim 2 wherein said selecting comprises acquiring identifiers of relevant metrics of the set of relevant metrics from the operator of the marketing engine.

6. The method of claim 1 wherein said ascertaining comprises:
initializing said respective set of target clusters for said each metric as an empty set;
for each cluster of said plurality of clusters:
determining a ratio of a respective metric-saturation level to mean metric-saturation level of remaining clusters;
adding said each cluster to said respective set of target clusters subject to a determination that said ratio exceeds a predefined singularity threshold.

7. The method of claim 1 wherein said ascertaining comprises processes of:
initalizing said respective set of target clusters as an empty set;
for each metric Mⱼ,0≤j<μ, μ being a number of metrics of said predefined set of metrics:
determining a summation Σⱼ of S_{j,0} to S_{j,(K-1)}, K being a number of clusters of said plurality of clusters and Sj,k being a saturation score of metric j within cluster k;
determining a singularity of metric-saturation of metric Mj within a cluster k, 0≤k<K, as:
η_{j,k}=(K-1)×S_{j,k}/(Σⱼ-S_{j,k});
and
subject to a determinadon that η_{j,k}>H, H being a predefined singularity threshold adding cluster k to said respecdve set of target clusters.

8.The method of claim 1 wherein said ascertaining comprises processes of: initializing said respective set of target clusters as an empty set;
for each metric Mⱼ, 0≤j≤μ, μ being a number of metrics of said set of candidate metrics:
determining a relative saturation α_{j,k} of Mⱼ, as α_{j,k}=S_{j,k}/ Qₖ, Qₖ being a total number of users of cluster k, 0≤k<K, K being a number of clusters of said plurality of clusters and Sj,k being a saturation score of metric j within cluster k;
determining a summation Γⱼ of α_{j,0} to α_{j,(K-1)};
determining a singularity λ_{j,k} of metric-singularity of metric M, within a cluster k, 0≤<K, as:
λ_{j,k}=(K-1)×α_{j,k}/ (Γⱼ-α_{j,k});
and
subject to a determination that λ_{j,k}<H, H being a predefined singularity threshold adding cluster k to said set of bearing clusters.

9. A method of machine-aided marketing comprising:
employing at least one processor for executing processor-readable instructions for:
obtaining an identifier of a commodity;
identifying a set of relevant metrics to the commodity from a predefined set of metrics of personal behaviour,
determining a metric-relevance level of each said relevant metric;
determining a metric-saturation level of each relevant metric within each cluster of a set of clusters of users of a plurality of users of social-media;
determining a relevance-weighted metric-saturation level for each relevant metric for each cluster; and
determining a commodity-specific cluster merit for each cluster of the superset of clusters as a function of respective relevance-weighted saturation levels; determining a set of target clusters comprising each cluster having a cluster merit surpassing a prescribed threshold; and
communicating with users belonging to said set of target clusters;
thereby, enabling machine-aided communication with prospective clients of a commodity under consideration.

10. The method of claim 9 further comprising specifying the set of relevant metrics and a metric-relevance level of each said relevant metric.

11. The method of claim 9 further comprising determining the set of relevant metrics and corresponding metric-relevance level of each relevant metric according to metric-relevance indications of individual consumers of a set of past consumers of the commodity.

12. The method of claim 9 wherein the plurality of users is segmented into the set of clusters according to mutual affinity of individual users.

13. The method of claim 9 further comprising determining a metric-saturation of a specific metric within a specific cluster as a function of a proportion of users within the specific cluster to which the specific metric pertains.

14. The method of claim 9 further comprising determining the relevance weighted metric saturation level of a specific metric within a specific cluster as a product of a metric-relevance level of the specific metric and a metric-sauration of the specific metric within the specific cluster.

15. A method of machine-aided markedng comprising:
employing at least one processor executing instructions for:
receiving an identifier of a commodity;
identifying a set of relevant metrics to the commodity from a predefined set of metrics of personal behaviour;
determining a metric-relevance level of each said relevant metric;
determining a metric-saturauon level of each relevant metric within each cluster of a set of clusters of users of a plurality of users of social-media;
determining a relevance-weighted metric-saturadon level for each relevant metric for each cluster; and
determining a commodity-specific cluster merit for each cluster of the superset of clusters as a funcdon of respecdve relevance-weighted saturadon levels;
determining a set of target clusters comprising each cluster having a cluster merit surpassing a prescribed threshold;
forming a set of communides having a one-to-one correspondence to the set of relevant metrics, each community comprising users to which a relevant metric pertains;
determining a union of:
the set of target clusters; and
the set of communities; and
communicating with users belonging to said union; thereby, enabling machine-aided communication with prospective clients of a commodity under consideration.

16. An apparatus for machine-aided marketing comprising:
at least one memory device storing processor-executable instructions, for execution by at least one processor, organized into:
a network interface for tracking users;
a module for acquisition of users' characterization data from a first plurality of tracked users;
a module for segmenting the first plurality of tracked users into a plurality of clusters according to said users' characterization data;
a module for acquisition of metrics of a predefined set of metrics representing behaviour of a second plurality of tracked users;
a module for determining a metric-saturation level of each metric in each cluster of said plurality of clusters as a function of a proportion of users within said each cluster to which said each metric pertains; and
a module for determining for said each metric a respective set of target clusters within said plurality of clusters according to said metric-saturation level;
thereby, enabling automated marketing functions.

17. The apparatus of claim 16 further comprising:
a module for:
receiving an identifier of a specific commodity from an operator of the apparatus; and
selecting a set of relevant metrics of the predefined set of metrics for the specific commodity according to metric-relevance indications of individual consumers of a set of past consumers of the commodity.

18. The apparatus of claim 17 further comprising:
a module for:
determining a union of sets of target clusters corresponding to the set of relevant metrics; and
communicating with users belonging to said union of sets of target clusters.

19. The apparatus of claim 16 further comprising a module for acquisition of apparatus customization data from an administrator.

20. The apparatus of claim 16 further comprising a module for routing data to users through said network interface.

21. An apparatus for machine-aided marketing comprising:
a processor and at least one memory device having processor-executable instructions stored thereon causing the processor to:
acquire users' characterization data from a first plurality of tracked users;
segment the first plurality of tracked users into a plurality of clusters according to said users' characterization data;
acquire metrics of a predefined set of metrics representing behaviour of a second plurality of tracked users;
determine a metric saturation level of each said metric in each cluster of said plurality of clusters as a function of a number of users within said each cluster to which said each metric pertains; and
determine for said each metric a respective set of target clusters within said plurality of clusters according to said metric-saturation level;
thereby, providing information for automated marketing functions.
